(19) United States
(12) Patent Application Publication
(10) Pub. No.: US 2026/0250580 A1
(43) Pub. Date: Aug. 27, 2026

(54) INTEGRATED FISCHER-TROPSCH PROCESSES

(71) Applicants: BP P.L.C., London (GB); BP (CHINA) HOLDINGS LIMITED, Shanghai (CN)

(72) Inventors: Meiling Guo, Shanghai (CN); Gareth Gerald Armitage, York (GB); John Glenn Sunley, London (GB); Xuebin Liu, Shanghai (CN); Ben Dennis-Smither, London (GB); Christiana Udoh, London (GB); Alexander James Paterson, Hull (GB)

(21) Appl. No.: 18/877,204

(22) PCT Filed: Jun. 29, 2023
(86) PCT No.: PCT/IB2023/056801

§ 371 Date: Dec. 19, 2024

(30) Foreign Application Priority Data
Jun. 30, 2022 (WO) PCT/CN2022/102724

(51) Int. Cl. C10G 2/00; C10K 3/02

(52) U.S. Cl. CPC C10G 2/333; C10K 3/026; C10G 2300/4006; C10G 2300/70

(57) ABSTRACT

The present disclosure relates generally to a process for performing an integrated Fischer-Tropsch process, the process comprising: providing a first feed stream comprising H₂ and CO₂; contacting at a first temperature in the range of 200-900° C. and at a first pressure a reverse water-gas shift catalyst with the first feed stream to perform a reverse water-gas shift reaction to provide a first product stream comprising CO and H₂, the first product stream having a lower concentration of CO₂ and a higher concentration of CO than the first feed stream; contacting at a second temperature and at a second pressure a Fischer-Tropsch catalyst with a second feed stream comprising H₂ and at least a portion of CO of the first product stream to provide a second product stream comprising C₅₊ hydrocarbons.

### CROSS-REFERENCE TO RELATED APPLICATIONS

This application claims the benefit of priority of International Patent Application no. PCT/CN2022/102724, filed Jun. 30, 2022, which is hereby incorporated herein by reference in its entirety.

### BACKGROUND OF THE DISCLOSURE

### 1. Field

The present disclosure relates generally to reverse water-gas shift catalysts, processes of making the same, and processes for performing reverse water-gas shift reactions. The present disclosure also relates to integrating processes for performing reverse water-gas shift reactions with processes for performing Fischer-Tropsch reactions.

### 2. Technical Background

The reverse water-gas shift reaction (rWGS) is an advantageous route to obtain carbon monoxide from carbon dioxide for further chemical processing. The rWGS converts carbon dioxide and hydrogen to carbon monoxide and water, as shown in Equation (1).

$${CO}_{2} + {H}_{2} ⇌ CO + {H}_{2} O \qquad Eq . ( 1 )$$

$${{ΔH}^{0}}_{298} = 42.1 {kJmol}^{- 1}$$

This can be used, for example, to modify the CO:H₂ ratio of a gas mixture for further processing. The carbon monoxide and hydrogen so formed is a valuable feedstock for a number of chemical processes, for example, the well-known Fischer-Tropsch (FT) process, shown in Equation (2).

$$CO + 2 {H}_{2} ⇌ [ - {CH}_{2} - ] + {H}_{2} O \qquad Eq . ( 2 )$$

$${{ΔH}^{0}}_{298} = - 152 {kJmol}^{- 1}$$

However, the rWGS reaction is not favored in all circumstances. For example, a competing reaction is the Sabatier reaction (Equation (3)), which decreases carbon monoxide yield in favor of methane production, which is not an active feedstock for FT.

$${CO}_{2} + 4 {H}_{2} ⇌ {CH}_{4} + 2 {H}_{2} O \qquad Eq . ( 3 )$$

$${{ΔH}^{0}}_{298} = - 165 {kJmol}^{- 1}$$

The strongly exothermic Sabatier reaction is thermodynamically favored over the endothermic rWGS reaction at lower reaction temperatures. As such, minimizing the methanation during rWGS, especially at low temperatures, can become a significant challenge.

Similarly, the carbon monoxide product from rWGS can be hydrogenated to methane, as shown in Equation (4).

$${CO}_{2} + 3 {H}_{2} ⇌ {CH}_{4} + {H}_{2} O \qquad Eq . ( 4 )$$

$${{ΔH}^{0}}_{298} = - 206.5 {kJmol}^{- 1}$$

Hydrogenation of carbon monoxide to methane is also an exothermic reaction, so it too is favored at lower temperatures. The stoichiometry of the reaction requires at least a 3:1 ratio of hydrogen to carbon monoxide. This means that performing the rWGS reaction with a large excess of hydrogen to drive the equilibrium toward carbon monoxide (see Equation (1)) is not always ideal because it runs the risk of hydrogenating the carbon monoxide product to form methane.

Coupled with Equations (3) and (4), further undesirable side reactions can occur. These side reactions can form undesirable carbon deposits on the surface of catalysts used to promote rWGS. Examples of these carbon-producing side reactions are shown in Equations (5), (6), and (7). All three of these reactions are endothermic and are favored at higher temperatures, just like the rWGS reaction.

$$CO + {H}_{2} ↔ C + {H}_{2} O \qquad Eq . ( 5 )$$

$${{ΔH}^{0}}_{298} = 131 {kJmol}^{- 1}$$

$${CH}_{4} ↔ 2 {H}_{2} + C \qquad Eq . ( 6 )$$

$${{ΔH}^{0}}_{298} = 75 {kJmol}^{- 1}$$

$$2 CO ↔ {CO}_{2} + C \qquad Eq . ( 7 )$$

$${{ΔH}^{0}}_{298} = 171 {kJmol}^{- 1}$$

Accordingly, because the carbon-producing side reactions (Equations (5)-(7)) are also endothermic and are favored at higher temperatures, operation at higher temperatures to favor the desired carbon monoxide product can severely impact catalyst lifetime through the deposition of carbon.

Given the multiple reactions and competing thermodynamics at play, there remains a need in the art for new integration with Fischer-Tropsch processes.

### SUMMARY

In one aspect, the present disclosure provides for a process for performing an integrated Fischer-Tropsch process, the process comprising:
providing a first feed stream comprising H₂ and CO₂;
contacting at a first temperature in the range of 200-900° C. and at a first pressure a reverse water-gas shift catalyst with the first feed stream to perform a reverse water-gas shift reaction to provide a first product stream comprising CO and H₂, the first product stream having a lower concentration of CO₂ and a higher concentration of CO than the first feed stream;
contacting at a second temperature and at a second pressure a Fischer-Tropsch catalyst with a second feed stream comprising H₂ and at least a portion of CO of the first product stream to provide a second product stream comprising C₅₊ hydrocarbons.

### BRIEF DESCRIPTION OF FIGURES

FIG. 1 is a schematic of a process for performing an integrated Fischer-Tropsch process as described herein.

FIG. 2 is a schematic of a process for performing an integrated Fischer-Tropsch process as described herein.

FIG. 3 is a schematic of a process for performing an integrated Fischer-Tropsch process as described herein.

FIG. 4 is a schematic of a process for performing an integrated Fischer-Tropsch process as described herein.

FIG. 5 is a schematic of a process for performing an integrated Fischer-Tropsch process as described herein.

FIG. 6 is a schematic of a process for performing an integrated Fischer-Tropsch process as described herein.

### DETAILED DESCRIPTION

As discussed above, the reverse gas-water shift reaction reacts carbon dioxide with hydrogen to form carbon monoxide and water and can be useful in providing a feedstock containing carbon monoxide and hydrogen—often called “synthesis gas”—for use in processes such as the Fischer-Tropsch process. However, the Sabatier reaction, carbon monoxide methanation, and carbon-producing side reactions can interfere with the rWGS reaction. The Sabatier reaction and CO methanation are exothermic and favored at lower temperatures, while the rWGS and carbon-producing side reactions are endothermic and favored at higher temperatures. Accordingly, there remains a need for reverse water-gas shift processes to be integrated with Fischer-Tropsch processes.

In one aspect, the present disclosure provides a process for performing an integrated Fischer-Tropsch process, the process includes providing a first feed stream comprising H₂ and CO₂; contacting at a first temperature in the range of 200-900° C. and at a first pressure a reverse water-gas shift catalyst with the first feed stream to perform a reverse water-gas shift reaction to provide a first product stream comprising CO and H₂, the first product stream having a lower concentration of CO₂ and a higher concentration of CO than the first feed stream; contacting at a second temperature and at a second pressure a Fischer-Tropsch catalyst with a second feed stream comprising H₂ and at least a portion of CO of the first product stream to provide a second product stream comprising C₅₊ hydrocarbons.

The processes as described here include contacting a reverse water-gas shift catalyst with the first feed stream as described herein. The reverse water-gas shift catalyst is not particularly limited and the person of ordinary skill in the art would be able to select an appropriate catalyst. For example, the person or ordinary skill in the art would be able to select a catalyst as described in Daza et al. “CO₂ conversion by reverse water gas shift catalysis: comparison of catalysts, mechanisms and their consequences for CO₂ conversion to liquid fuels.” RSC Adv., 2016, 6, 49675-49691, Zhu et al. “Catalytic Reduction of CO₂ to CO via Reverse Water Gas Shift Reaction: Recent Advances in the Design of Active and Selective Supported Metal Catalyst.” Transaction of Tianjin University, 2020, 26, 172-187, and Chen et al. “Recent Advances in Supported Metal Catalysts and Oxide Catalyst for the Reverse Water-Gas Shift Reaction.” Front. Chem., 2020, 8, 709. These catalysts include rWGS active metals. For example, such active metals may be selected from copper, platinum, palladium, rhodium, rhenium, ruthenium, nickel, gold, and iridium or combinations thereof.

The reverse water-gas shift catalysts suitable for use in the process as described herein can be a variety of forms and are not particularly limited. For example, the reverse water-gas shift catalyst may be a supported or unsupported catalyst. While the form of the catalyst is not particularly limited, in various desirable embodiments, the reverse water-gas shift catalyst is a supported catalyst, wherein the support comprises at least one of titanium oxide, zirconium oxide, cerium oxide, aluminum oxide, silicon oxide and zinc oxide. For example, in various embodiments, the support comprises least one of titanium oxide, zirconium oxide, cerium oxide, and aluminum oxide. In some embodiments of the present disclosure as described herein, the support is a titanium dioxide support. In some embodiments of the present disclosure as described herein, the support is a zirconium dioxide support. In some embodiments of the present disclosure as described herein, the support is a cerium dioxide support. In some embodiments of the present disclosure as described herein, the support is an aluminum dioxide support.

The person of ordinary skill in the art will appreciate that the reverse water-gas shift catalysts of the disclosure can be provided in many forms, depending especially on the particular form of the reactor system in which they are to be used, e.g., in a fixed bed or as a fluidized bed. The supports of the reverse water-gas shift catalysts can be provided themselves as discrete bodies of material, e.g., as porous particles, pellets or shaped extrudates, with the metals provided thereon to provide the reverse water-gas shift catalyst. However, in other embodiments, a reverse water-gas shift catalyst of the disclosure can itself be formed as a layer on an underlying substrate. The underlying substrate is not particularly limited. It can be formed of, e.g., a metal or metal oxide, and can itself be provided in a number of forms, such as particles, pellets, shaped extrudates, or monoliths. The person of ordinary skill in the art will select an appropriate Fischer-Tropsch catalyst for the particular reactor system.

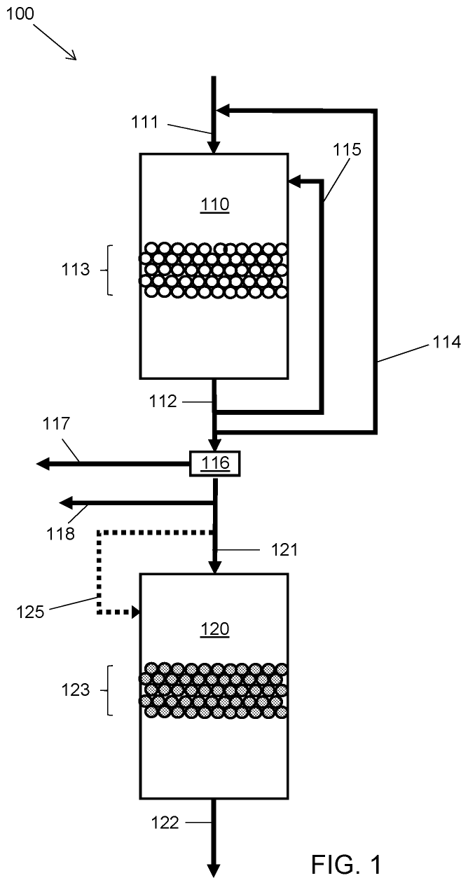

The process includes providing a first feed stream comprising H₂ and CO₂; contacting at a first temperature in the range of 200-900° C. and at a first pressure a reverse water-gas shift catalyst, as described herein, with the first feed stream to perform a reverse water-gas shift reaction to provide a first product stream comprising CO and H₂, the first product stream having a lower concentration of CO₂ and a higher concentration of CO than the first stream feed stream. An example of such a process is shown schematically in FIG. 1. In FIG. 1, the process 100 includes performing a reverse water-gas shift reaction by providing a first feed stream 111 comprising H₂ and CO₂, here, to a first reaction zone, e.g., a reactor 110. A reverse water-gas shift catalyst 113, as described herein, is contacted at a first temperature in the range of 200-900° C. and at a first pressure with the feed stream 111 to provide a first product stream 112 comprising CO and H₂. The first product stream has a lower concentration of CO₂ and a higher concentration of CO than the first feed stream. The process of this aspect of the disclosure also includes contacting at a second temperature and at a second pressure a Fischer-Tropsch catalyst with a second feed stream comprising H₂ and at least a portion of CO of the first product stream to provide a second product stream comprising C₅₊ hydrocarbons, In the process 100 of FIG. 1, at least a portion of CO of the first product stream 112 is included in second feed stream 121, which is contacted with Fischer-Tropsch catalyst 123, here, in a second reaction zone (e.g., a reactor 120). This provides a second product stream 122, which includes C₅₊ hydrocarbons.

As used herein, a “feed stream” is used to mean the total material input to a process step, e.g., reverse water-gas shift or Fischer-Tropsch reaction, regardless of whether provided in a single physical stream or multiple physical streams, and whether through a single inlet or multiple inlets. For example, H₂ and CO of the first feed stream can be provided to the reverse water-gas shift catalyst in a single physical stream (e.g., in a single pipe to reactor 110), or in multiple physical streams (e.g., separate inlets for CO and H₂, or one inlet for fresh CO and H₂ and another for recycled CO and/or H₂). Similarly, a “product stream” is used to mean the total material output from a process step, e.g., reverse water-gas shift or Fischer-Tropsch reaction, regardless of whether provided in a single physical stream or multiple physical streams, and whether through a single outlet or multiple outlets.

As described above, the first feed stream contains both H₂ and CO₂ (e.g., provided to a reaction zone in a single physical stream or multiple physical streams). In various embodiments as otherwise described herein, the molar ratio of H₂ to CO₂ in the first feed stream is at least 0.1:1, e.g., at least 0.5:1. In some embodiments, the molar ratio of H₂ to CO₂ in the first feed stream is at least 0.9:1, e.g., at least 1:1 or at least 1.5:1. In some embodiments, the molar ratio of H₂ to CO₂ in the first feed stream is at least 2:1, e.g., at least 2.5:1. In some embodiments, the molar ratio of H₂ to CO₂ in the first feed stream is no more than 100:1, e.g., no more than 75:1 or no more than 50:1. In some embodiments, the molar ratio of H₂ to CO₂ in the first feed stream is no more than 20:1, e.g., no more than 15:1 or no more than 10:1. For example, in some embodiments, the molar ratio of H₂ to CO₂ in the first feed stream is in the range of 0.5:1 to 10:1. The person of ordinary skill in the art will provide a desired ratio of H₂:CO₂ in the first feed stream, based on the disclosure herein, that provides a desirable conversion and selectivity; excess H₂ can, if consistent with a desirable conversion and selectivity, be provided to flow through the system and provide a first product stream with a desirable ratio of H₂ to CO for a downstream process, e.g., a Fischer-Tropsch process.

Other gases may also be included in the first feed stream. For example, in some embodiments, the first feed stream further comprises CO. In some embodiments of the disclosure as otherwise described herein, the first feed stream further comprises one or more inert gases. For example, in some embodiments, the first feed stream further comprises nitrogen and/or methane.

The process as described herein includes contacting a rWGS catalyst with the first feed stream to perform the rWGS reaction. Notably, the present inventors have determined that the rWGS catalysts described herein can provide desirably high CO selectivities. For example, in various embodiments of the present disclosure as described herein, the reverse water-gas shift reaction has a CO selectivity of at least 70%, e.g., of at least 80%. In various embodiments, the reverse water-gas shift reaction has a CO selectivity of at least 85%, e.g., or at least 90%. In various embodiments, the reverse water-gas shift reaction has a CO selectivity of at least 95%, e.g., or at least 96%. As used herein, a “selectivity” for a given reaction product is the molar fraction of the relevant component of the feed (here, CO₂) that is converted to the product (for “CO selectivity,” CO). The present inventors have determined that the present rWGS catalysts as described herein, even when operating at lower temperatures than many conventional reverse water-gas shift catalysts, can provide excellent selectivity for CO, despite the potential for competition by the Sabatier reaction and the methanation of CO. For example, in some embodiments as otherwise described herein, the reverse water-gas shift reaction has a CO selectivity of at least 98%, e.g., or at least 99%.

Notably, even over a broad range of temperatures, e.g., within the range of 200-900° C., the rWGS catalysts described herein can be operated to provide carbon monoxide with only a very minor degree of methane formation. For example, in various embodiments of the present disclosure as described herein, the reverse water-gas shift reaction has a methane selectivity of no more than 5%, e.g., no more than 4%. For example, in some embodiments, the reverse water-gas shift reaction has a methane selectivity of no more than 2%, e.g., no more than 1%. In some embodiments, the reverse water-gas shift reaction has a methane selectivity of no more than 0.5%, e.g., no more than 0.2%.

The present inventors have determined that the rWGS catalysts described here can provide desirably high CO selectivity and desirably low methane selectivity at commercially relevant conversion rates. As used herein, a “conversion” is a molar fraction of a relevant component feed that is reacted (be it to desirable products or undesirable species). In various embodiments of the present disclosure as described herein, the reverse water-gas shift reaction has a CO₂ conversion of at least 5%, e.g., at least 10%, or at least 20%. For example, in some embodiments, the reverse water-gas shift reaction has a CO₂ conversion of at least 30%, e.g., at least 40%, or at least 50%, or at least 60%. In various embodiments of the present disclosure as described herein, the reverse water-gas shift reaction has a CO₂ conversion of no more than 90%, e.g., no more than 80%, or no more than 70%. For example, in some embodiments, the reverse water-gas shift reaction has a CO₂ conversion of no more than 65%, e.g., no more than 60%. For example, in various embodiments as otherwise described herein, the CO₂ conversion is in the range of 10-90%, e.g., 10-80%, or 10-70%, or 10-60%, or 10-65%, or 20-90%, or 20-80%, or 20-70%, or 20-60%, or 20-65%, or 30-90%, or 30-80%, or 30-70%, or 30-60%, or 30-65%, or 40-90%, or 40-80%, or 40-70%, or 40-60%, or 40-65%. The person of ordinary skill in the art will, based on the disclosure herein, operate at a degree of conversion that provides a desirable product. And of course, in other embodiments, e.g., when in a stacked-bed or mixed-bed system, the effective CO₂ conversion may be even higher than described here.

Advantageously, the rWGS processes described herein can be performed at temperatures that are lower than temperatures used in many conventional reverse water-gas shift processes. As described above, various processes of performing a rWGS reaction of the disclosure can be performed at a first temperature in the range of 200-900° C. For example, in some embodiments, the reverse water-gas shift reaction is conducted at a first temperature in the range of 200-850° C., or 200-800° C., or 200-750° C., or 200-700° C., or 200-650° C., or 200-600° C. In some embodiments of the present disclosure as described herein, the process for performing the reverse water-gas shift reaction is conducted at a first temperature in the range of 250-900° C., e.g., in the range of 250-850° C., or 250-800° C., or 250-750° C., or 250-700° C., or 250-650° C., or 250-600° C. In some embodiments of the present disclosure as described herein, the process for performing the reverse water-gas shift reaction is conducted at a first temperature in the range of 300-900° C., e.g., in the range of 300-850° C., or 300-800° C., or 300-750° C., or 300-700° C., or 300-650° C., or 300-600° C. In some embodiments of the present disclosure as described herein, the process for performing the reverse water-gas shift reaction is conducted at a first temperature in the range of 350-900° C., e.g., in the range of 350-850° C., or 350-800° C., or 350-750° C., or 350-700° C., or 350-650° C., or 350-600° C. In some embodiments, the process for performing the reverse water-gas shift reaction is conducted at a first temperature in the range of 400-900° C., e.g., in the range of 400-850° C., or 400-800° C., or 400-750° C., or 400-700° C., or 400-650° C., or 400-600° C. In some embodiments, the process for performing the reverse water-gas shift reaction is conducted at a first temperature in the range of 450-900° C., e.g., in the range of 450-850° C., or 450-800° C., or 450-750° C., or 450-700° C., or 450-650° C., or 450-600° C. In some embodiments, the process for performing the reverse water-gas shift reaction is conducted at a first temperature in the range of 500-900° C., e.g., in the range of 500-850° C., or 500-800° C., or 500-750° C., or 500-700° C., or 500-650° C., or 500-600° C. In some embodiments, the process for performing the reverse water-gas shift reaction is conducted at a first temperature in the range of 550-900° C., e.g., in the range of 550-850° C., or 550-800° C., or 550-750° C., or 550-700° C., or 550-650° C., or 550-600° C.

In some embodiments, the reverse water-gas shift reaction is conducted at a first temperature in the range of 200-500° C., e.g., 200-450° C., or 200-400° C., or 200-350° C., or 250-500° C., or 250-450° C., or 250-400° C., or 250-350° C. The present inventors have noted that operation at these temperatures can provide for lower energy demand, as well as for facile integration with a subsequent Fischer-Tropsch process step.

Additionally, the rWGS processes described herein can be performed at a variety of pressures, as would be appreciated by the person of ordinary skill in the art. In various embodiments of the present disclosure, the process for performing the reverse water-gas shift reaction is conducted at a first pressure in the range of 1 to 100 barg. For example, the rWGS process is conducted at a first pressure in the range of 1 to 70 barg, or 1 to 50 barg, or 1 to 40 barg, or 1 to 35 barg, or 5 to 70 barg, or 5 to 50 barg, or 5 to 40 barg, or 5 to 35 barg, or 10 to 70 barg, 10 to 50 barg, or 10 to 40 barg, or 10 to 35 barg, or 20 to 70 barg, 20 to 50 barg, or 20 to 40 barg, or 20 to 35 barg, or 25 to 70 barg, 25 to 50 barg, or 25 to 40 barg, or 25 to 35 barg.

The rWGS processes described herein can be performed at a variety of GHSV (gas hourly space velocity), as would be appreciated by the person of ordinary skill in the art. As such, the GHSV for performing the reverse water-gas shift reaction is not particularly limited. For example, in some embodiments of the present disclosure, the process for performing the reverse water-gas shift reaction is conducted at a GHSV in the range of 1,000 to 2,000,000 h⁻¹. In various embodiments, the process for performing the reverse water-gas shift reaction is conducted at a GHSV in the range of 1,000 to 1,200,000 h⁻¹, or 1,000 to 500,000 h⁻¹, or 1,000 to 100,000 h⁻¹, or 5,000 to 1,200,000 h⁻¹, or 5,000 to 500,000 h⁻¹, or 5,000 to 100,000 h⁻¹, or 10,000 to 1,200,000 h⁻¹, or 10,000 to 500,000 h⁻¹, or 10,000 to 100,000 h⁻¹. In various embodiments of the present disclose, the process for performing the reverse water-gas shift reaction is conducted at a GHSV in the range of 1,000 to 50,000 h⁻¹, or 2,000 to 50,000 h⁻¹, or 5,000 to 50,000 h⁻¹, or 10,000 to 50,000, or 1,000 to 40,000 h⁻¹, or 2,000 to 40,000 h⁻¹, or 5,000 to 40,000 h⁻¹, or 10,000 to 40,000 h⁻¹, or 1,000 to 30,000 h⁻¹, or 2,000 to 30,000 h⁻¹, or 5,000 to 30,000 h⁻¹, or 10,000 to 30,000 h⁻¹.

It will typically be desirable to activate the rWGS catalyst, e.g., before contacting with the first feed stream. Thus in some embodiments of the present disclosure as described herein, the process comprises activating the rWGS catalyst prior to contacting the catalyst with the feed stream. For example, in some embodiments, activating the catalyst comprises contacting the catalyst with a reducing stream comprising a reductive gas, e.g., hydrogen. In various embodiments of the present disclose, the reducing stream comprises hydrogen in an amount of at least 25 mol %, e.g., at least 50 mol %, or 75 mol %, or 90 mol %. The person of ordinary skill in the art will determine suitable conditions for reducing activation of the rWGS catalyst. As such, the person or ordinary skill in the art would be able to choose an appropriate temperature, pressure, and time for activating the rWGS catalyst. For example, in various embodiments activating the rWGS catalyst is conducted at a temperature in the range of 200° C. to 800° C. For example, in various embodiment, activating the rWGS catalyst is conducted at a temperature in the range of 250° C. to 800° C., or 300° C. to 800° C., or 200° C. to 700° C., or 250° C. to 800° C., or 300° C. to 700° C. In some embodiments of the present disclosure as described herein, activating the rWGS catalyst provides a rWGS catalyst that is at least 10% reduced (e.g., at least 25%, or at least 50% reduced).

The present inventors have found that contacting the rWGS catalysts as described herein with a first feed stream can provide a first product stream with advantageously high CO selectivity and low methane selectivity. The amount of CO in the first product stream can be further controlled by the rWGS reaction conditions, as described above. But in general, the processes for performing the rWGS reaction as described herein, provide a first product stream comprising H₂ and CO, with the first product stream having a lower concentration of CO₂ and a higher concentration of CO than the first feed stream, as is consistent with the degrees of conversion and selectivities described herein. For example, in various embodiments, the first product stream includes no more than 95 mol % CO₂, or no more than 90 mol % CO₂. In some embodiments, the first product stream includes no more than 85 mol % CO₂, or no more than 80 mol % CO₂. In other examples, the first product stream includes no more than 75 mol %, or no more than 70 mol % CO₂.

However, as described above, the present inventors have determined that it can be desirable to perform the processes at intermediate degrees of conversion to provide desirably high CO selectivities and desirably low methane selectivities. Moreover, the present inventors have noted that it can be advantageous to perform the downstream Fischer-Tropsch process with a relatively high level of inerts, and thus contemplate that passing a significant amount of CO₂ to the Fischer-Tropsch process step can be beneficial. Accordingly, in various embodiments as otherwise described herein, the first product stream includes an amount of CO₂ together with the CO. In various embodiments, the first product stream comprises in the range of 5-95 mol % CO₂, e.g., 5-90 mol %, or 5-85 mol %, or 5-80 mol %, or 5-75 mol %, or 5-70 mol %, or 10-95 mol %, or 10-90 mol %, or 10-85 mol %, or 10-80 mol %, or 10-75 mol %, or 10-70 mol %, or 20-95 mol %, or 20-90 mol %, or 20-85 mol %, or 20-80 mol %, or 20-75 mol %, or 20-70 mol %, or 30-95 mol %, or 30-90 mol %, or 30-85 mol %, or 30-80 mol %, or 30-75 mol %, or 30-70 mol % CO₂.

Other gases may also be included in the first product stream. In some embodiments of the disclosure as otherwise described herein, the first product stream further comprises one or more inert gases. These inert gases may be included from the first feed stream or provided from a source other than the first feed stream. For example, in some embodiments, the first product stream further comprises nitrogen and/or methane.

Depending on, inter alia, the degree of conversion, the CO selectivity, the relative amounts of H₂ and CO₂ in the first feed stream, and the reaction conditions, the first product stream can include H₂ in combination with CO, in a variety of ratios. For example, in some embodiments, the ratio of H₂:CO in the first product stream is in the range of 0.1:1 to 100:1 (e.g., in the range of 0.1:1 to 50:1, or 0.1:1 to 25:1, or 0.1:1 to 10:1, or 0.1:1 to 5:1, or 1:1 to 100:1, or 1:1 to 50:1, or 1:1 to 25:1, or 1:1 to 10:1, or 1:1 to 5:1).

The person of ordinary skill in the art would appreciate that, based on the processes as described herein, the first product stream may include H₂, CO, and CO₂ and other components in various amounts. Components of the first product stream may be separated and used for various purposes in the integrated process.

For example, in various embodiments of the present disclosure as described herein, the process further comprises separating the first product stream to recycle at least a portion (e.g., at least 5 mol %, at least 10 mol %, at least 25 mol %, at least 50 mol %, at least 75 mol %, or at least 90 mol %) of one or more components of the first product stream to the first feed stream. For example, when the first product stream includes CO₂, the process can include recycling at least a portion (e.g., at least 5 mol %, at least 10 mol %, at least 25 mol %, at least 50 mol %, at least 75 mol %, or at least 90 mol %) of the CO₂ of the first product stream to the first feed stream. The first product stream may also include H₂; in some embodiments, the process further includes recycling at least a portion of H₂ of the first product stream (e.g., at least 5 mol %, at least 10 mol %, at least 25 mol %, at least 50 mol %, at least 75 mol %, or at least 90 mol %) to the first feed stream.

Such recycling is shown in the process 100 of FIG. 1. Here, the process 100 includes separating from the first product stream 112 at least a portion of CO₂ (stream 114) to recycle to the first feed stream 111. Similarly, the process 100 includes separating from the first product stream 112 at least a portion of H₂ (stream 115) to recycle to the first product stream 111. While stream 115 is depicted as entering reactor 110 through a different inlet than the rest of the first feed stream 111, it is considered to be part of the first feed stream, as it is part of the material input to the process step.

Moreover, as described below, Fischer-Tropsch catalysts typically require activation by a reducing gas. As would be understood by the person of skill in the art, different Fischer-Tropsch catalysts required different activation conditions (e.g., gas composition, temperature, pressure, time). For example, iron based Fischer-Tropsch catalysts require activation with both H₂ and CO, while cobalt based Fischer-Tropsch catalysts require activation with just H₂. As such, H₂ and CO or just H₂ from the first product stream can be used to perform this activation. Accordingly, in various embodiments as otherwise described herein, the process includes separating at least a portion of H₂ and CO (desirably in a ratio of at least 1:1 or at least 3:1) from the first product stream and contacting it with the Fischer-Tropsch catalyst to activate the Fischer-Tropsch catalyst. In various other embodiments as otherwise described herein, the process includes separating at least a portion of H₂ from the first product stream and contacting it with the Fischer-Tropsch catalyst to activate the Fischer-Tropsch catalyst. For example, in the process of FIG. 1, stream 125 separates H₂ or H₂ and CO and conducts it to reactor 120. This separation need not be continuous; rather, it need only be performed for a time desirable to provide reducing gas to the Fischer-Tropsch catalyst for activation. Of course, as would be understood by the person of skill in the art, other sources of H₂ or CO may be used to provide reducing gas to the Fischer-Tropsch catalyst for activation.

As shown above, water is a product of the reverse water-gas shift reaction. Accordingly, the first product stream will generally contain water. In many cases, it can be desirable to reduce the amount of water that is provided to the Fischer-Tropsch process step. Accordingly, in various embodiments as otherwise described herein, the process further includes removing at least a portion (e.g., at least 25%, at least 50%, or at least 75%) of water from the first product stream. In the embodiment of FIG. 1, a water removal zone 116 is used to remove water and provide a water-containing stream 117. The person of ordinary skill in the art will appreciate that a variety of processes can be used to remove water from the first product stream. For example, the first product stream can be contacted with a water scavenger to remove water therefrom. For example, a molecular sieve guard bed can be used to remove water from the first product stream; water can be recovered from the molecular sieves of the guard bed, e.g., by heating and vacuum. In other embodiments, a knockout vessel can be used. However, use of a knockout vessel can in some cases cool the first product stream enough so that it is desirably reheated for introduction to the Fischer-Tropsch process step. Water removed from the first product stream can be used, e.g., as feed water for electrolysis processes described herein.

As noted above, one competing reaction in the reverse water-gas shift reaction is the Sabatier reaction, which makes methane. While in various embodiments, the reverse water-gas shift processes described herein can be performed without forming large amounts of methane, in some embodiments there can be some methane formed. Accordingly, in various embodiments of the process as described herein, the first product stream comprises one or more light hydrocarbons. For example, in some embodiments, the first product stream may include one or more of methane, ethane, propane, or combinations thereof. As would be understood by the person of ordinary skill in the art, it may be desirable to operate the reverse water-gas shift reaction to provide higher amounts of light hydrocarbons in the first product feed. For example, such light hydrocarbons may be inert in further processing of the first product stream and so may be acceptable at higher amounts. The person of ordinary skill in the art would be able to select appropriate reaction conditions (e.g., temperature, pressure, first feed stream composition) to provide a first product stream that includes methane at a desired amount. For example, in various embodiments as otherwise described herein, the first product stream includes no more than 20 mol % methane or no more than 15 mol %. As noted above, when lower amounts of methane are desired in the first product stream, the rWGS catalysts of the disclosure can provide very low methane selectivity. Accordingly, in various embodiments as otherwise described herein, the first product stream includes no more than 10 mol % methane. For example, in various embodiments, the first product stream includes no more than 5 mol %, or no more than 1 mol %, or no more than 0.5 mol %, or no more than 0.1 mol % methane. In general, light hydrocarbons (e.g., C₁-C₅ hydrocarbons) may be present in the product stream. For example, in various embodiments as otherwise described herein, the product stream includes no more than 20 mol % light hydrocarbons (e.g., no more than 15 mol %, no more than 10 mol %, no more than 5 mol %, no more than 1 mol %, no more than 0.5 mol %, or no more than 0.1 no mol % light hydrocarbons).

These light hydrocarbons (e.g., C₁-C₅ hydrocarbons) can be separated and used for other purposes. For example, in various embodiments, the process further includes separating at least a portion of one or more light hydrocarbons from the first product stream to provide a light hydrocarbon stream. For example, in process 100 of FIG. 1, at least a portion of one or more light hydrocarbons are separated from the first product stream 112 to provide a light hydrocarbon stream 118. The light hydrocarbon stream, for example, can be used to provide other products, can be partially oxidized to form CO, can be steam reformed to provide hydrogen, and/or can be burned to provide heat or other energy (e.g., electricity for electrolysis) for use in the integrated process or otherwise.

Of course, as would be understood by the person of ordinary skill in the art, the light hydrocarbon stream may be used in other processes as well. For example, as would be understood by the person of ordinary skill in the art, some rWGS catalysts can have reforming capability. Without being bound by theory, the present inventors hypothesize that one explanation for the low methane production observed using the rWGS catalysts as described herein is that methane is formed but then immediately reformed into CO and H₂. Accordingly, in some embodiments as described herein, the light hydrocarbons of the process stream is recycled to the feed stream for the rWGS reaction.

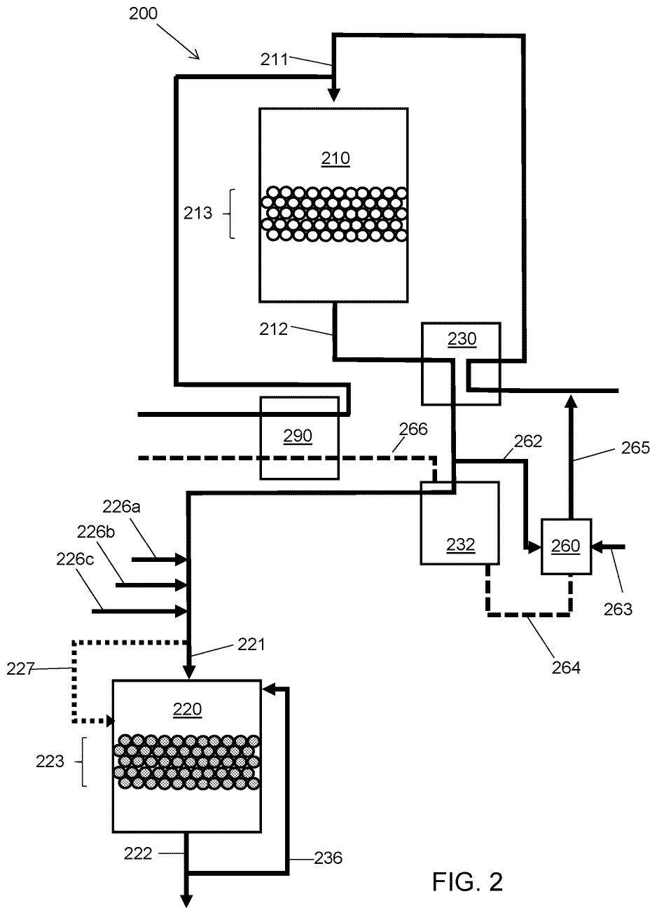

As noted above, the reverse water-gas shift process can be provided at a wide variety of temperatures. In some cases, those temperatures can be relatively close to the temperature of the subsequent Fischer-Tropsch process step (often 150-400° C., e.g., 200-350° C., or other temperatures as described below). In other cases, the reverse water-gas shift process can be performed at temperatures significantly higher than the temperature of the Fischer-Tropsch step. The present inventors have noted that it can be desirable to provide for heat exchange with a relatively hot first product stream to cool the first product stream to a temperature more appropriate for the Fischer Tropsch step and to provide heat elsewhere to the integrated process. For example, in various embodiments of the processes as otherwise described herein, the process further comprises exchanging heat between at least a portion of the first product stream and at least a portion of the first feed stream, thereby cooling at least a portion of the first product stream and heating at least a portion of the first feed stream. An example of such a process is shown schematically in FIG. 2. In FIG. 2, the process 200, first reactor 210, first feed stream 211, first product stream 212, reverse water-gas shift catalyst 213, second reactor 220, second feed stream 221, second product stream 222 and Fischer-Tropsch catalyst 223 are generally as described above. Here, the process 200 includes exchanging heat between at least a portion of the first product stream 212 and a least a portion of the first feed stream 211 in a first heat exchange zone 230, thereby cooling at least a portion of the first product stream 212 and heating at least a portion of the first feed stream 211. The person of ordinary skill in the art will appreciate that a wide variety of heat exchangers can be used for this purpose.

Of course, any excess heat in the first product stream can be additionally or alternatively used for other purposes. For example, in various embodiments the process further comprises exchanging heat between at least a portion of the first product stream and a steam generation zone, thereby cooling at least a portion of the first product stream and providing heat to the steam generation zone. This is shown in FIG. 2. Here, after heat exchange with the first feed stream 211, the first product stream 212 is conducted to steam generation zone 232, to cool the first product stream 212 and provide heat to the steam generation zone 232. Steam can be generated from the heat provided, and electricity can be generated from the steam. For example, in the embodiment of FIG. 2, electricity stream 264 is provided by the generation of electricity using steam generated in the steam generation zone 232. Of course, as would be understood to the person of ordinary skill in the art, the steam generated in the steam generation zone may be used in other processes. In various embodiments, the steam may be used to heat the first feed stream. For example, in the embodiment of FIG. 2, the steam stream 266 generated in the steam generation zone 232 is conducted to the heat exchange zone 290 to heat the first feed stream 211.

As noted above, at least a portion of the CO of the first product stream is included in the second feed stream, for reaction in a Fischer-Tropsch process. For example, in various embodiments as otherwise described herein, at least 25% of the CO of the first product stream, e.g., at least 50% of the CO, at least 75% of the CO, or at least 90% of the CO of the first product stream is included in the second feed stream. Of course, as noted above, some of the CO of the first product stream can be used for other purposes, e.g., catalyst activation as described herein.

In some embodiments, substantially all of the CO of the second feed stream comes from the first product stream. However, in other embodiments, CO can be provided to the second feed stream from other sources, fossil-derived or otherwise. For example, in various embodiments, CO is provided to the second feed stream from a CO source other than the first product stream. In FIG. 2, a stream of CO 226a from some other source is included in the second feed stream 221. The person of ordinary skill in the art will appreciate that CO can be provided from a variety of sources, e.g., gasification, reforming, or electrochemical CO₂ reduction. Moreover, as described in more detail below, CO can be recycled to the second feed stream from the second product stream; and/or can be provided by reaction of a light hydrocarbon stream, e.g., by partial oxidation or reforming (e.g., steam reforming and/or autothermal reforming).

As noted above, the second feed stream includes H₂. Notably, the first product stream will often include H₂, e.g., unreacted from the first feed stream. In various embodiments, the first product stream includes H₂ wherein the second feed stream includes at least a portion of the H₂ of the first product stream. For example, in various embodiments as otherwise described herein, at least 25% of the H₂ of the first product stream, e.g., at least 50% of the H₂, at least 75% of the H₂, or at least 90% of the H₂ of the first product stream is included in the second feed stream. Of course, as noted above, some of the H₂ of the first product stream can be used for other purposes, e.g., catalyst activation as described herein.

In some embodiments, substantially all of the H₂ of the second feed stream comes from the first product stream. In fact, the person of ordinary skill in the art can provide more H₂ than necessary for the reverse water-gas shift reaction in the first feed stream, to provide excess H₂ in the first product stream that can then provide a desired amount of H₂ to the second feed stream for the Fischer-Tropsch process step. However, in other embodiments, H₂ can be provided to the second feed stream from other sources. For example, in various embodiments, H₂ is provided to the second feed stream from a H₂ source other than the first product stream. In FIG. 2, a stream of H₂ 226b from some other source is included in the second feed stream 221. The person of ordinary skill in the art will appreciate that H₂ can be provided from a variety of sources, e.g., gasification, reforming, or H₂O electrolysis (including the electrolysis described herein). Moreover, as described in more detail below, H₂ can be recycled to the second feed stream from the second product stream.

The person of ordinary skill in the art can, based on the disclosure herein, adjust the relative amounts of H₂ and CO in the second feed stream to provide a desired ratio. For example, more or less H₂ of the first feed stream and/or more or less H₂ from electrolysis can be included in the second feed stream. Similarly, more or less CO of the first feed stream and more or less CO from other sources (e.g., partial oxidation and reforming as described below) can be included in the second feed stream.

As noted above, it can be desirable to perform the Fischer-Tropsch process step in the presence of a significant level of inerts. One such inert, CO₂, can come from the reverse water-gas shift, e.g., via the first product stream. Accordingly, in various embodiments as otherwise described herein, the second feed stream includes at least a portion of CO₂ of the first product stream. For example, in various embodiments, at least 10% of the CO₂ of the first product stream, e.g., at least 25% of the CO₂, at least 50% of the CO₂, at least 75% of the CO₂, or at least 90% of the CO₂ of the first product stream is included in the second feed stream. Of course, in other embodiments, the second feed stream may not include any substantial amount of CO₂ of the first product stream. Accordingly, in various embodiments, the second feed stream does not include a substantial amount of CO₂ of the first product stream. While it can be desirable generally to recycle CO₂ to the first feed stream for use in the reverse water-gas shift reaction, as described in more detail below, unreacted CO₂ can be recycled from the second product stream to the first feed stream.

But it can additionally or alternatively be desirable to include additional inert content to the second feed stream, be it CO₂ or other inerts such as nitrogen and methane. For example, in various embodiments, one or more inerts (e.g., CO₂, nitrogen and/or methane) are provided to the second feed stream from a source other than the first product stream. In FIG. 2, a stream of inert(s) 226c from some other source is included in the second feed stream 221. The person of ordinary skill in the art will appreciate that inerts can be provided from a variety of sources. Moreover, as described in more detail below, inerts can be recycled to the second feed stream from the second product stream.

As noted above, it can be desirable to perform the Fischer-Tropsch process step in the presence of inerts. Accordingly, in various embodiments as otherwise described herein, the portion of the first product stream that is included in the second feed stream has a CO₂ content in the range of 10-95 mol % CO₂, e.g., 10-90 mol %, or 10-85 mol %, or 10-80 mol %, or 10-75 mol %, or 10-70 mol %, or 20-95 mol %, or 20-90 mol %, or 20-85 mol %, or 20-80 mol %, or 20-75 mol %, or 20-70 mol %, or 30-95 mol %, or 30-90 mol %, or 30-85 mol %, or 30-80 mol %, or 30-75 mol %, or 30-70 mol % CO₂.

Other gases may also be included in the second feed stream, as described above. For example, as noted above, it can be desirable to perform the Fischer-Tropsch process step in the presence of a significant amount of inerts (i.e., components that are not H₂ or CO). For example, in various embodiments, the second feed stream includes up to 80 mol % of one or more inerts, e.g., in the range of 3-80 mol %, or 5-80 mol %, or 10-80 mol %, or 15-80 mol %, or 30-80 mol % of one or more inerts. In various embodiments, the second feed stream includes up to 70 mol % inerts, up to 60 mol % inerts, or up to 50 mol % inerts, e.g., 3-70 mol %, or 5-70 mol %, or 10-70 mol %, or 15-70 mol %, or 30-70 mol %, or 3-60 mol %, or 5-60 mol %, or 10-60 mol %, or 15-60 mol %, or 30-60 mol %, or 3-50 mol %, or 5-50 mol %, or 10-50 mol %, or 15-50 mol %, or 30-50 mol % inerts. In various embodiments, the second feed stream includes up to 80% of one or more inerts selected from CO₂, methane and nitrogen, e.g., up to 70 mol %, up to 60 mol %, or up to 50 mol %, or 15-70 mol %, or 30-70 mol %, or 15-60 mol %, or 30-60 mol %, or 15-50 mol %, or 30-50 mol %. In various embodiments, the second feed stream includes up to 80 mol % of CO₂, e.g., up to 70 mol %, up to 60 mol %, or up to 50 mol %, or 15-70 mol %, or 30-70 mol %, or 15-60 mol %, or 30-60 mol %, or 15-50 mol %, or 30-50 mol %.

The person of ordinary skill in the art can tune the portion of the first product stream that is included in the second feed stream to provide a desirable H₂:CO ratio. For example in various embodiments, the portion of the first product stream that is included in the second feed stream has a H₂:CO ratio in the range of 0.5:1 to 10:1, e.g., in the range of 1:1 to 2.5:1. Of course, whatever the H₂:CO ratio of the portion of the first product stream that is included in the second feed stream, the person of ordinary skill in the art can add H₂ or CO as described above as necessary to provide the desired ratio overall in the second feed stream.

As described above, the second feed stream contains both H₂ and CO and the second feed stream includes all feeds to the Fischer Tropsch reactor, regardless of whether the second feed stream is provided as a mixture of feeds or as feeds provided individually to a reaction zone. In various embodiments of the present disclosure as described herein, the second feed stream has a H₂:CO ratio in the range of 0.5:1 to 6:1. In some embodiments, the second feed stream has a H₂:CO ratio in the range of 1:1 to 3:1, or 1:1 to 2.5:1. In some embodiments, the second feed stream has a H₂:CO ratio of at least 1.4:1. For example, in some embodiments, the second feed stream has a H₂:CO ratio in the range of 1.4:1 to 3:1, or 1.4:1 to 2:1. The person of ordinary skill in the art will provide a desired ratio of H₂:CO in the second feed stream, based on the disclosure herein that provides a desirable conversion and selectivity in the Fischer-Tropsch process.

As noted above it can be desirable to reduce the amount of water that is conducted to the Fischer-Tropsch process step. Accordingly, in various embodiments as otherwise described herein, the portion of the first product stream that is included in the second feed stream has a water content of no more than 10 mol %, e.g., or no more than 2 mol %, or no more than 0.5 mol %.

And as noted above, it can be desirable to perform the Fischer-Tropsch process with a relatively small amount of water present. Accordingly, in various embodiments, the second feed stream has a water content of no more than 10 mol %, e.g., or no more than 2 mol %, or no more than 0.5 mol %.

The processes as described here include contacting a Fischer-Tropsch catalyst with the second feed stream as described herein. The Fischer-Tropsch catalyst for use in the processes as described herein is not particularly limited and the person of ordinary skill in the art would be able to choose a catalyst as appropriate for their desired Fischer-Tropsch product. In some embodiments, the Fischer-Tropsch catalyst includes cobalt, iron, rhodium, ruthenium, or a combination thereof.

For example, in some embodiments of the present disclosure as described herein, the Fischer-Tropsch catalyst comprises cobalt, e.g., in an amount in the range of 5-25 wt %, calculated as Co(0). “Calculated as Co(0)” and analogous terms mean that the weight of cobalt atoms/ions themselves are used in the calculation, and not the total amount of any compound or polynuclear ion in which those cobalt atoms/ions might be bound. For example, in various embodiments, the Fischer-Tropsch catalyst comprises cobalt in an amount in the range of 7-25 wt %, or 10-25 wt %, or 5-20 wt %, or 7-20 wt %, or 10-20 wt %, calculated as Co(0). As the person of ordinary skill in the art will appreciate, cobalt-based catalysts are often provided to the reaction zone in the form of cobalt oxide on a support; the cobalt can be reductively activated (e.g., with H₂) in situ to provide an active catalyst species with a significant concentration of Co(0).

In some embodiments, the Fischer-Tropsch catalyst comprises iron, e.g., in an amount in the range of 5-95 wt %, calculated as Fe(0). For example, in various embodiments, the Fischer-Tropsch catalyst comprises iron in the range of 10-95 wt %, or 25-95 wt %, or 50-95 wt %, or 5-85 wt %, or 10-85 wt %, or 25-85 wt %, or 50-85 wt %, or 5-75 wt %, or 10-75 wt %, or 25-75 wt %, calculated as Fe(0). As the person of ordinary skill in the art will appreciate, iron-based catalysts are often provided to the reaction zone in the form of metallic iron or iron oxide, optionally on a support; the iron can be activated (e.g., by reaction with H₂ and CO) to provide an active catalyst species with a significant concentration of iron carbide.

In various embodiments of the disclosure as described herein, especially when the catalyst is a cobalt-based catalyst, the Fischer-Tropsch catalyst further includes manganese. For example, in various embodiments, the Fischer-Tropsch catalyst includes manganese in an amount up to 15 wt %, e.g., up to 12 wt %, or up to 10 wt %, or up to 7 wt %, calculated as Mn(0). In certain such embodiments, a catalyst material includes manganese in an amount in the range of 0.1-15 wt %, e.g., 0.1-10 wt %, or 0.1-5 wt %, 0.5-15 wt %, or 0.5-10 wt %, or 0.5-5 wt %, or calculated as Mn(0). Of course, in other embodiments substantially no manganese is present (e.g., less than 0.1 wt % or less than 0.5 wt % manganese is present).

The Fischer-Tropsch catalysts suitable for use in the process as described herein can be a variety of forms and are not particularly limited. For example, the Fischer-Tropsch catalyst may be a supported or unsupported catalyst. While the form of the catalyst is not particularly limited, in various desirable embodiments, the Fischer-Tropsch catalyst is a supported catalyst, wherein the support comprises at least one of titanium oxide, zirconium oxide, cerium oxide, aluminum oxide, silicon oxide and zinc oxide. For example, in various embodiments, the support comprises at least one or titanium oxide, aluminum oxide, and silicon oxide. In some embodiments of the present disclosure as described herein, the support is a titanium dioxide support.

The person of ordinary skill in the art will appreciate that the Fischer-Tropsch catalysts of the disclosure can be provided in many forms, depending especially on the particular form of the reactor system in which they are to be used, e.g., in a fixed bed or as a fluidized bed. The supports of the Fischer-Tropsch catalysts can be provided themselves as discrete bodies of material, e.g., as porous particles, pellets or shaped extrudates, with the metals provided thereon to provide the Fischer-Tropsch catalyst. However, in other embodiments, a Fischer-Tropsch catalyst of the disclosure can itself be formed as a layer on an underlying substrate. The underlying substrate is not particularly limited. It can be formed of, e.g., a metal or metal oxide, and can itself be provided in a number of forms, such as particles, pellets, shaped extrudates, or monoliths. The person of ordinary skill in the art will select an appropriate Fischer-Tropsch catalyst for the particular reactor system.

As with the rWGS catalyst, Fischer-Tropsch catalysts are typically activated before use, e.g., to provide cobalt(0) species on a cobalt-based catalyst, or iron carbide species on an iron-based catalyst. Such activation can be performed prior to contacting the Fischer-Tropsch catalyst with a second feed stream.

For example, in some embodiments, the Fischer-Tropsch catalyst is activated by contact with a reducing gas. For example, hydrogen can be an especially suitable gas for activating Fischer-Tropsch catalyst, e.g., when the activation is a reduction to metal(0) species, e.g., as for many cobalt-based catalysts. In various embodiments of the present disclosure as otherwise described herein, the reducing gas comprises at least a portion of H₂ from the first product stream. For example, in some embodiments, the process further comprises separating at least a portion of H₂ of the first product stream and contacting it with the Fischer-Tropsch catalyst to activate Fischer-Tropsch catalyst. In the process 100 shown schematically in FIG. 1, at least a portion of hydrogen stream 125 is separated from the first product stream 112 and contacted with the Fischer-Tropsch catalyst 123 to activate it. In other embodiments, H₂ present in the second feed stream can be used to activate the catalyst. As would be understood by the person of ordinary skill in the art, activation temperatures can vary depending on the Fischer-Tropsch catalyst used. As such, the person of ordinary skill in the art would be able to select an appropriate temperature for activating the catalyst, e.g., in the range of 200-400° C.

In various embodiments, the Fischer-Tropsch catalyst is activated by contact with H₂ and CO. This can be especially suitable when the activation provides conversion to carbide, e.g., as for many iron-based catalysts. In various embodiments of the present disclosure as otherwise described herein, the reducing gas comprises at least a portion of H₂ and CO from the first product stream. For example, in some embodiments, the process further comprises separating at least a portion of H₂ and at least a portion of CO of the first product stream and contacting it with the Fischer-Tropsch catalyst to activate Fischer-Tropsch catalyst. In the process 200 shown schematically in FIG. 2, at least a portion of H₂ and CO stream 227 is separated from the first product stream 212 and contacted with the Fischer-Tropsch catalyst 223 to activate it. In other embodiments, H₂ and CO present in the second feed stream can be used to activate the catalyst. Activation temperatures can vary, e.g., in the range of 200-400° C.

As described above, the process includes contacting at a second temperature and at a second pressure a Fischer-Tropsch catalyst with a second feed stream. The person of ordinary skill in the art will select appropriate reaction conditions in conjunction with the particular feed and catalyst used to provide desired Fischer-Tropsch processes. In some embodiments of the disclosure as described herein, the second temperature is in the range of 150-400° C. For example, in various embodiments, the second temperature is in the range of 150-350° C., or 150-300° C., or 150-250° C., or 150-200° C., or 200-400° C., or 200-350° C., or 200-300° C., or 200-250° C., or 250-400° C., or 250-350° C., or 250-300° C., or 300-400° C. In some particular embodiments, the second temperature is in the range of 200-350° C.

Notably, in many embodiments, the first temperature and the second temperature can be relatively close to one another. The present inventors have noted that the reverse water-gas shift catalysts described herein can provide suitable activity and CO selectivity even at relatively low temperatures. Accordingly, the first product stream can be provided with a temperature that is suitable for, or at least close to suitable for, the Fischer-Tropsch reaction step. This can desirably provide for increased process integration. For example, in various embodiments, the first temperature is within 100° C. of the second temperature, e.g., within 50° C. of the second temperature, or within 25° C. of the second temperature.

However, in other embodiments, the first temperature and the second temperature are less close to one another. The present inventors have noted that in many cases a desirable reverse water-gas shift process temperature will be significantly greater than a desirable Fischer-Tropsch process temperature. For example, in various embodiments, the first temperature is at least 100° C. greater than the second temperature, e.g., at least 150° C. greater than the second temperature, or at least 200° C. greater than the second temperature. The excess heat in the first product stream can be used for a number of purposes, for example, to preheat at least part of the first feed stream or to generate steam for use in generating electricity, as described above.

In some embodiments of the disclosure as described herein, the second pressure is in the range of 10-50 barg. For example, in various embodiments, the second pressure is in the range of 20-50 barg, or 25-50 barg, or 10-40 barg, or 20-40 barg, or 25-40 barg or 10-35 barg, or 20-35 barg, or 25-35 barg. In some embodiments, the second pressure is in the range of 20-50 barg.

The Fischer-Tropsch processes described herein can be performed at a variety of GHSV (gas hourly space velocity) values, as would be appreciated by the person of ordinary skill in the art. As such, the GHSV for performing the Fischer-Tropsch reaction is not particularly limited. For example, in some embodiments of the present disclosure, the process for performing the Fischer-Tropsch reaction is conducted at a GHSV in the range of 1,000 to 2,000,000 h⁻¹. In various embodiments, the process for performing the reverse water-gas shift reaction is conducted at a GHSV in the range of 1,000 to 1,200,000 h⁻¹, or 1,000 to 500,000 h⁻¹, or 1,000 to 100,000 h⁻¹, or 5,000 to 1,200,000 h⁻¹, or 5,000 to 500,000 h⁻¹, or 5,000 to 100,000 h⁻¹, or 10,000 to 1,200,000 h⁻¹, or 10,000 to 500,000 h⁻¹, or 10,000 to 100,000 h⁻¹. In various embodiments of the present disclose, the process for performing the Fischer-Tropsch reaction is conducted at a GHSV in the range of 1,000 to 50,000 h⁻¹, or 2,000 to 50,000 h⁻¹, or 5,000 to 50,000 h⁻¹, or 10,000 to 50,000, or 1,000 to 40,000 h⁻¹, or 2,000 to 40,000 h⁻¹, or 5,000 to 40,000 h⁻¹, or 10,000 to 40,000 h⁻¹, or 1,000 to 30,000 h⁻¹, or 2,000 to 30,000 h⁻¹, or 5,000 to 30,000 h⁻¹, or 10,000 to 30,000 h⁻¹.

The Fischer-Tropsch process is typically used to make C₅₊ hydrocarbons, for example, unsubstituted C₅₊ hydrocarbons (e.g., alkanes and alkenes) and oxygenated C₅₊ hydrocarbons (e.g., C₅₊ alcohols, aldehydes, ketones, carboxylic acids). In various embodiments of the disclosure as described herein, contacting the Fischer-Tropsch catalyst with the second feed stream to provide the second product stream is performed with a C₅₊ selectivity (i.e., for all C₅₊ species) of at least 30%, e.g., at least 50%, or at least 70%. For example, in some embodiments, the selectivity for C₅₊ alkanes is at least 30%, e.g., at least 50%, or at least 70%. In some embodiments, the selectivity for C₅₊ alkanes and C₅₊ alcohols is at least 30%, e.g., at least 50%, or at least 70%.

Additional components may be in present in the second product stream. For example, in some embodiments, the second product stream includes water, which is another product of the Fischer-Tropsch reaction. Also present can be one or more light hydrocarbons (i.e., C₁-C₄) as a side product. CO and/or H₂ can be present, e.g., unreacted from the second feed stream. CO₂ or other inerts as described herein can also be present. Such components of the second product stream can be separated and/or recycled in various manners.

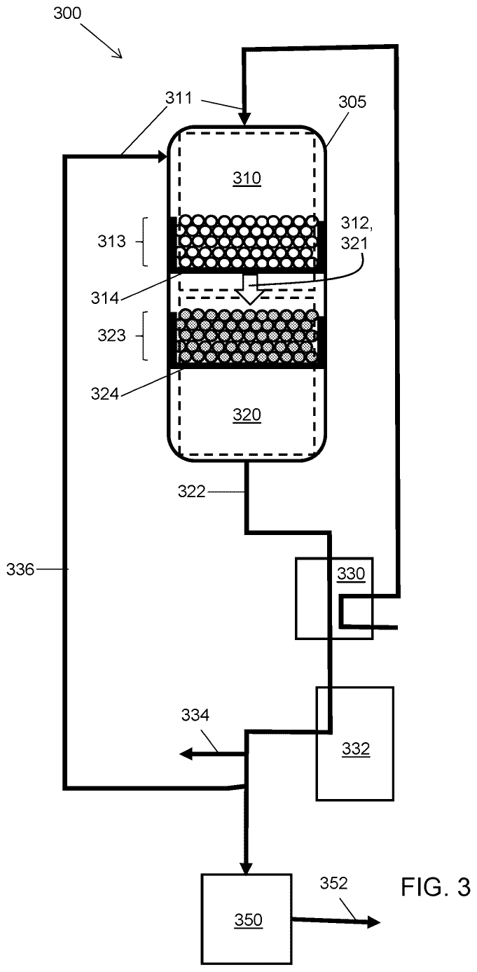

For example, in various embodiments, the process further comprises separating at least a portion of water from the second product stream. This is shown schematically in FIG. 3. In the embodiment of FIG. 3, the reverse water-gas shift catalyst 313 and the Fischer-Tropsch catalyst 323 are provided in separate beds in the same reactor. Thus, the first reaction zone 310 is a volume of the reactor 305 that includes the bed 314 containing the reverse water-gas shift catalyst 313, and the second reaction zone 320 is a volume of the reactor 305 that includes the bed 324 containing the Fischer-Tropsch catalyst 323. First feed stream 311 is contacted with the reverse water-gas shift catalyst 313 to provide first product stream 312, which is passed directly as the second feed stream 321 to the Fischer-Tropsch catalyst 323 to provide second product stream 322. Here, the process also optionally includes separating at least a portion of water (e.g., at least 50%, at least 75%, or at least 90%) from the second product stream 322 to provide water-containing stream 334.

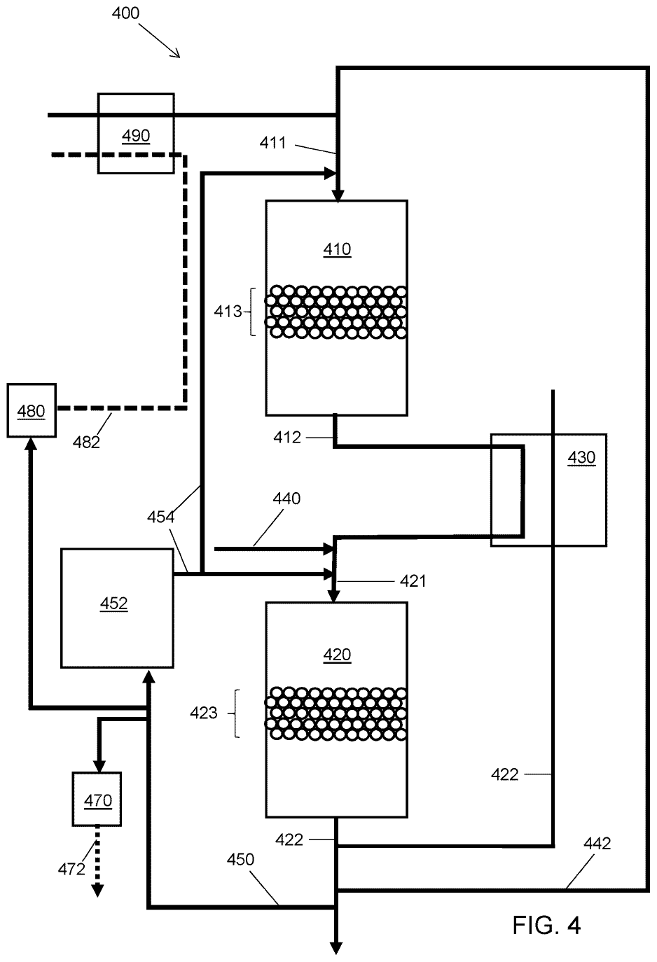

Light hydrocarbons, while often not a desired portion of a Fischer-Tropsch product to be used as a fuel or a lubricant, can themselves be useful for a number of purposes. Accordingly, in various embodiments, the process further includes separating at least a portion of C₁-C₄ hydrocarbons from the second product stream to provide a light hydrocarbon stream. The light hydrocarbon stream can, for example, be recycled to the first feed stream or the second feed stream. For example, in the process 200 of FIG. 2, light hydrocarbons can be provided as part of the recycle stream 236, which becomes part of the second feed stream 221. In the process 300 of FIG. 3, light hydrocarbons can be provided as part of the recycle stream 336, which becomes part of the first feed stream 311. In the process 400 of FIG. 4, light hydrocarbons are recycled via recycle stream 442 to first feed stream 411.

There are other uses for the light hydrocarbon stream. For example, in some embodiments, the process further comprises oxidizing at least a portion of the light hydrocarbon stream to provide a CO- and/or CO-containing partial oxidation (pOX) stream, and including at least a portion of the pOX stream in the first feed stream and/or the second feed stream. An example of such a process is shown schematically in FIG. 4, in which the process 400, the first feed stream 411, the first product stream 412, the reverse water-gas shift catalyst 413, the second feed stream 421, the second product stream 422 and the Fischer-Tropsch catalyst 423 can be as otherwise described herein. Here, the process includes oxidizing at least a portion of the light hydrocarbon stream 450) in a partial oxidation reaction zone 452 to provide a CO- and/or CO₂ containing pOX stream, and including at least a portion of the pOX stream 454 stream in the first feed stream 411 and/or the second feed stream 421.

Other methods can be used to provide CO and/or CO₂ from the light hydrocarbon stream. For example, reforming techniques such as steam reforming and autothermal reforming can be used to provide CO by reaction of hydrocarbons with water. Accordingly, in various embodiments, the process further comprises reforming (e.g., steam reforming and/or autothermal reforming) at least a portion of the light hydrocarbon stream to provide a CO- and/or CO₂-containing reformed stream, and including at least a portion of the reformed stream in the first feed stream and/or the second feed stream. Water separated from the first and/or second product streams can be provided as part of a feed to the reforming described here.

Moreover, the light hydrocarbon stream can be burned to provide heat energy, which can be used to heat various process streams, or to generate electricity. Accordingly, in various embodiments, the process includes burning at least a portion of the light hydrocarbon stream to provide energy, e.g., heat energy or electrical energy. For example, in the process 400 of FIG. 4, a portion of light hydrocarbon stream 450 is burned in a power generation zone (here, in an electrical generator 470), to generate electricity stream 472. In various embodiments, the heat energy may be used to provide the needed heat duty for the reverse water-gas shift process. For example, in the process 400 of FIG. 4, a portion of the light hydrocarbon stream 450 is burned in a power generation zone (here, in a heat generator 480), to generate heat stream 482. The heat stream 482 is conducted to a heat exchange zone 490 to heat the first feed stream 411. Heat energy can similarly be provided to the Fischer-Tropsch reaction. And as the person of ordinary skill in the art will appreciate, other treatments of the light hydrocarbon stream (e.g., partial oxidation) can also provide energy, which can be used, e.g., as described herein.

As with the first product stream, heat can be exchanged from the second product stream to provide heat to, for example, a feed stream or a steam generation zone. For example, in various embodiments, the process further comprises exchanging heat between at least a portion of the second product stream and at least a portion of the first feed stream, thereby cooling at least a portion of the second product stream and heating at least a portion of the first feed stream. In process 300 of FIG. 3, heat is exchanged between at least a portion of the second product stream 322 and first feed stream 311 in a second heat exchange zone 330, thereby cooling the second product stream 322 and heating the first feed stream 311. Of course, heat can also be exchanged from the second product stream to the second feed stream. For example, in various embodiments, the process further comprises exchanging heat between at least a portion of the second product stream and at least a portion of the second feed stream, thereby cooling at least a portion of the second product stream and heating at least a portion of the second feed stream. In process 400 of FIG. 4, heat is exchanged between at least a portion of the second product stream 422 and second feed stream 421 in a second heat exchange zone 430, thereby cooling the second product stream 422 and heating the second feed stream 421. The person of ordinary skill in the art will appreciate that a wide variety of heat exchangers can be used for this purpose.

Of course, any excess heat in the second product stream can be additionally or alternatively used for other purposes. For example, in various embodiments the process further comprises exchanging heat between at least a portion of the second product stream and a steam generation zone, thereby cooling at least a portion of the second product stream and providing heat to the steam generation zone. This is shown in FIG. 3. Here, after heat exchange with the first feed stream 311, the second product stream 322 is conducted to steam generation zone 332, to cool the second product stream 322 and provide heat to the steam generation zone 332. Steam can be generated from the heat provided, and electricity can be generated from the steam (not shown here).

It can be desirable to recycle hydrogen from the second product stream, for example, to the first feed stream and/or the second feed stream. For example, in various embodiments, the process includes recycling at least a portion of H₂ of the second product stream to the second feed stream. For example, in the process of FIG. 2, at least a portion of H₂ of the second product stream (e.g., at least 25%, at least 50%, or at least 75%) can be recycled to the second feed stream 221 via recycle stream 236. In various embodiments, the process includes recycling at least a portion of H₂ of the second product stream to the first feed stream. For example, in the process of FIG. 3, at least a portion of H₂ of the second product stream (e.g., at least 25%, at least 50%, or at least 75%) can be recycled to the first feed stream 311 via recycle stream 336. In various embodiments, at least 25%, e.g., at least 50% of H₂ of the second product stream is recycled to the first feed stream or the second feed stream. In various embodiments, at least 75%, e.g., at least 90% of H₂ of the second product stream is recycled to the first feed stream or the second feed stream.

In some cases, e.g., when H₂ is provided to the second feed stream from an H₂ source other than the first product stream, H₂ from the second product stream can make up most of the H₂ of the first feed stream, e.g., at least 90%, at least 95%, or at least 98% of the H₂ of the first feed stream. This is shown, e.g., in FIG. 4. Here, the primary H₂ input to the process is through stream 440, which becomes part of the second feed stream 421. H₂ of the second product stream is included in recycle stream 442, which becomes part of first feed stream 411.

Similarly, it can be desirable to recycle CO of the second product stream, for example, to the first feed stream and/or the second feed stream. For example, in various embodiments, the process includes recycling at least a portion of CO of the second product stream to the second feed stream. For example, in the process of FIG. 2, at least a portion of CO of the second product stream (e.g., at least 25%, at least 50%, or at least 75%) can be recycled to the second feed stream 221 via recycle stream 236. In various embodiments, the process includes recycling at least a portion of CO of the second product stream to the first feed stream. For example, in the process of FIG. 3, at least a portion of CO of the second product stream (e.g., at least 25%, at least 50%, or at least 75%) can be recycled to the first feed stream 311 via recycle stream 336. In various embodiments, at least 25%, e.g., at least 50% of CO of the second product stream is recycled to the first feed stream or the second feed stream. In various embodiments, at least 75%, e.g., at least 90% of CO of the second product stream is recycled to the first feed stream or the second feed stream.

In many cases, both CO and H₂ of the second product stream will be recycled.

Moreover, when one or more inerts are used in the Fischer-Tropsch process step, it can be desirable to recycle these. For example, in various embodiments, the process includes recycling at least a portion of inerts of the second product stream to the second feed stream. For example, in the process of FIG. 2, at least a portion of inerts of the second product stream (e.g., at least 25%, at least 50%, or at least 75%) can be recycled to the second feed stream 221 via recycle stream 236. In various embodiments, the process includes recycling at least a portion of inerts of the second product stream to the first feed stream. For example, in the process of FIG. 3, at least a portion of inerts of the second product stream (e.g., at least 25%, at least 50%, or at least 75%) can be recycled to the first feed stream 311 via recycle stream 336. In various embodiments, at least 25%, e.g., at least 50% of inerts of the second product stream is recycled to the first feed stream or the second feed stream. In various embodiments, at least 75%, e.g., at least 90% of inerts of the second product stream is recycled to the first feed stream or the second feed stream. In various embodiments, a purge stream can be incorporated with the recycle stream to prevent uncontrolled accumulation of inerts in the recycle stream (not shown here).

Specifically, as CO₂ is the carbon source for the reverse water-gas shift process step, it can be especially desirable to recycle CO₂ to the first feed stream. Accordingly, in various embodiments, the process includes recycling at least a portion (e.g., at least 50%, at least 75%, or at least 90%) of CO₂ of the second product stream to the first feed stream. For example, in the process of FIG. 3, at least a portion of CO₂ of the second product stream (e.g., at least 50%, at least 75%, or at least 90%) can be recycled to the first feed stream 311 via recycle stream 336.

In some cases, e.g., when CO₂ is provided to the second feed stream from a CO₂ source other than the first product stream, CO₂ from the second product stream can make up most of the CO₂ of the first feed stream, e.g., at least 90%, at least 95%, or at least 98% of the CO₂ of the first feed stream. This is shown, e.g., in FIG. 4. Here, the primary CO₂ input to the process is through stream 440, which becomes part of the second feed stream 421. CO₂ of the second product stream is included in recycle stream 442, which becomes part of first feed stream 411.

As noted above, the Fischer-Tropsch process step provides a second product stream that includes C₅₊ hydrocarbons (e.g., unsubstituted hydrocarbons like alkanes and alkenes, and/or oxygenated hydrocarbons such as alcohols). Accordingly, in various embodiments, one or more products are provided from at least a portion of C₅₊ hydrocarbons of the second product stream. The C₅₊ hydrocarbons can be used as the basis of a variety of fuels, e.g., gasoline, diesel, aviation fuel. Other products, like waxes and lubricants, can also be made. And alkenes and oxygenates can be used as feedstocks in a variety of other processes.

The person of ordinary skill in the art will use conventional post-processing techniques to convert the C₅₊ hydrocarbon-containing product to desirable products such as desirable fuels. For example, in various embodiments, the process further includes hydroprocessing at least a portion of C₅₊ hydrocarbons of the second product stream. As the person of ordinary skill in the art will appreciate, hydroprocessing is a treatment of the hydrocarbon stream with hydrogen in the presence of a suitable catalyst. A wide variety of hydroprocessing techniques are known and the person of ordinary skill in the art will apply them here. For example, in the process 300 of FIG. 3, second product stream 322 is hydroprocessed in hydroprocessing reactor 350, to provide a hydroprocessed product stream 352.

As described above, CO₂ and H₂ are substantial inputs to the claimed processes. Advantageously, the present inventors have recognized that each of these can come from renewable or otherwise environmentally responsible sources.

CO₂ can be captured from the environment generally or more directly from processes that form CO₂ (especially in difficult-to-abate sectors). This can make the eventual hydrocarbon product substantially carbon-neutral or of lower carbon intensity. Accordingly, in some embodiments of the disclosure as described herein, at least a part of the CO₂ of the first feed stream and/or the second feed stream is from a renewable source. In some embodiments, at least part (e.g., at least 25%, at least 50%, or at least 75%) of the CO₂ of the first feed stream and/or the second feed stream is from direct air capture. In some embodiments, at least part (e.g., at least 25%, at least 50%, or at least 75%) of the CO₂ of the first feed stream and/or the second feed stream is from a manufacturing plant such as a bioethanol plant (e.g., CO₂ produced fermentation), a steel plant, or a cement plant. Accordingly, the rWGS-Fischer Tropsch integrated processes of the disclosure as described herein can be not only carbon neutral, but in some cases a net consumer of carbon dioxide. These benefits in particular make the integrated processes highly attractive for decarbonizing transportation fuels, for both automotive and aviation sectors, since the carbon monoxide produced in the rWGS reaction can be readily utilized by well-established technologies to synthesize liquid hydrocarbon fuels by Fischer-Tropsch processes.

Similarly, H₂ can be provided from environmentally-responsible sources. In some embodiments, at least a part of the H₂ of the first feed stream and/or the second feed stream is from a renewable source. For example, in various embodiments, at least part (e.g., at least 25%, at least 50%, or at least 75%) of the H₂ of the first feed stream and/or the second feed stream can be so-called “green” hydrogen, e.g., produced from the electrolysis of water operated using renewable electricity (such as wind, solar, or hydro-electric power). In some embodiments, at least part (e.g., at least 25%, at least 50%, or at least 75%) of the H₂ of the first feed stream and/or the second feed stream may be from a so-called “blue” source, e.g., from a natural gas reforming process with carbon capture. Of course, other sources of H₂ can be used in part or in full. For example, in some embodiments, at least part (e.g., at least 25%, at least 50%, or at least 75%) of the H₂ of the first feed stream and/or the second feed stream is grey hydrogen, black hydrogen, brown hydrogen, pink hydrogen, turquoise hydrogen, yellow hydrogen, and/or white hydrogen.

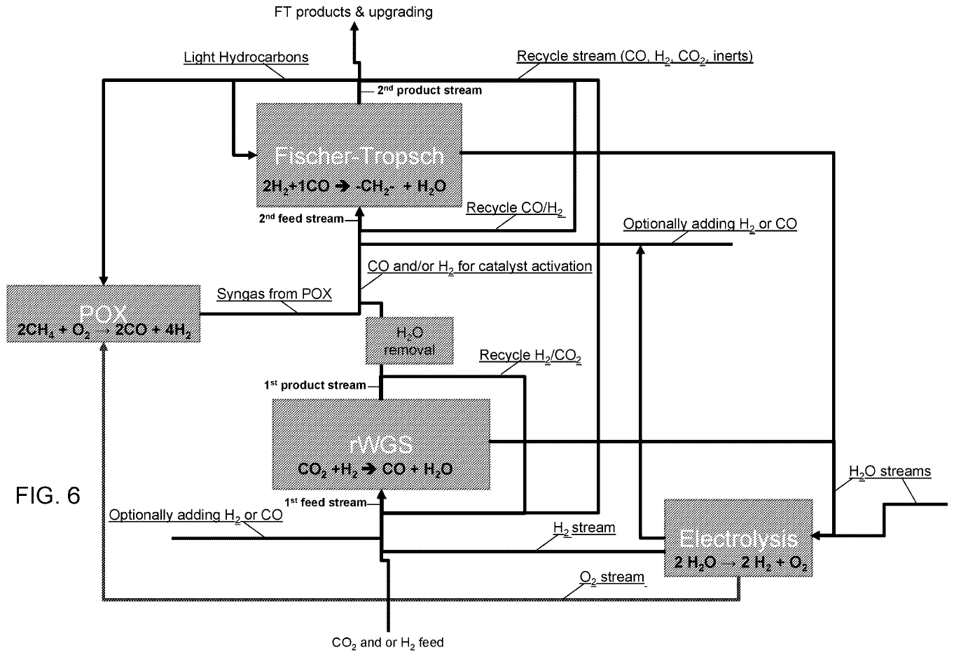

The present inventors have noted that electrolysis of water is a desirable way to provide hydrogen to the claimed processes. Accordingly, in some embodiments, the process includes providing at least a portion of H₂ to the first feed stream and/or the second feed stream by electrolysis of water. In some embodiments, the electrolysis of water is performed using at least partially electricity from a renewable source, e.g., to provide so-called “green hydrogen.” However, the present inventors have noted that electricity can be generated as part of the claimed process, e.g., using heat exchange from the first or second product stream, or by burning light hydrocarbons as described above. In some embodiments, the electrolysis of water is performed using at least partially electricity generated according to the processes as described herein. For example, in the process 200 of FIG. 2, water 262 separated from the first product stream is electrolyzed in electrolyzer 260, using electricity 264 generated from steam made in the steam generation zone 232 by heat exchange from the first product stream. H₂ generated in the electrolysis is provided via stream 265 to the first feed stream. In some embodiments, at least a portion of O₂ generated in the electrolysis is provided to a partial oxidation reaction zone as described herein and as shown in the embodiment of FIG. 6. Hydrogen from electrolysis can also burned to provide heat energy, e.g., which can be used to heat the first feed stream.

The processes described herein can be operated in a wide variety of reactor systems. In some embodiments, the first reaction zone (i.e., in which the reverse water-gas shift process step is performed) comprises a first reactor in which a reverse water-gas shift catalyst is disposed, and the second reaction zone (i.e., in which the Fischer-Tropsch process step is performed) comprises a second reactor in which the Fischer-Tropsch catalyst is disposed. Examples of such processes are shown schematically in FIGS. 1, 2, and 4. In these examples, the process (100, 200, 400) is performed in a reactor system that includes a first reactor (110, 210, 410) in which a reverse water-gas shift catalyst (113, 213, 413) is disposed, and a second reactor (120, 220, 420) in which the Fischer-Tropsch catalyst (123, 223, 423) is disposed. The reactors used for the integrated process of the present disclosure as described herein are not particularly limited, and the person of ordinary skill in the art will be able to select an appropriate reactor.

But other embodiments are possible. For example, in some embodiments, the process is performed in a reactor system comprising first catalyst bed in which the reverse water-gas shift catalyst is disposed, and wherein the second reaction zone comprises a second catalyst bed in which the Fischer-Tropsch catalyst is disposed. In some embodiments, the first reactor bed and the second reactor bed are disposed within the same reactor. Such a configuration is shown in FIG. 3, in which the reverse water-gas shift catalyst 313 is disposed in a first catalyst bed 314, and the Fischer-Tropsch catalyst 323 is disposed in a second catalyst bed 324. Here, the catalyst beds 314 and 324 are in the same reactor 305, with process gases flowing between them. Such a configuration can be especially desirable when the first temperature and the second temperature are relatively close to one another.

In various embodiments, the process is performed in a reactor system comprising one or more first catalyst containers in which the reverse water-gas shift catalyst is disposed, and wherein the second reaction zone comprises one or more second catalyst containers in which the Fischer-Tropsch catalyst is disposed. These can be provided in the same reactor, such as described above with respect to catalyst beds.

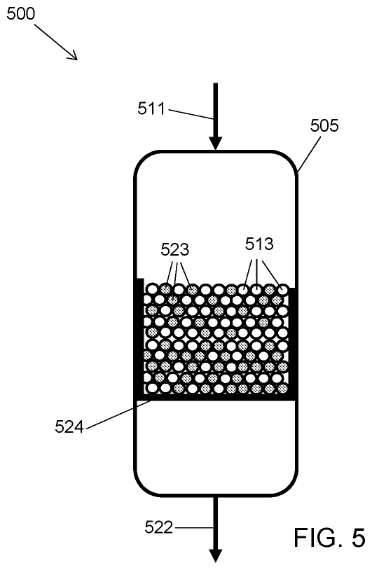

As noted above, the reverse water-gas shift process step using the catalysts described herein and the Fischer-Tropsch process step can be performed under similar conditions. Accordingly, in various embodiments, the reverse water-gas shift catalyst and the Fischer-Tropsch catalyst can be provided together in the same catalyst bed, e.g., mixed together. Such an embodiment is shown in FIG. 5. Here, the process 500 is performed in a reactor system that includes a reactor 505 in which the reverse water-gas shift catalyst 513 and the Fischer-Tropsch catalyst 523 are mixed together in a single catalyst bed 524. Here, first feed stream 511 and second product stream 522 can be substantially as described herein. The first product stream and the second feed stream are understood to be the mixture of process gases within the mixed catalysts.

In the embodiments particularly-described above, separate rWGS and Fischer-Tropsch catalysts are used, e.g., in separate reactors, in separate regions of the same reactor, or even comingled in the same region of a reactor.

However, the present inventors also note that there are certain commonalities between the rWGS catalysts described herein and certain Fischer-Tropsch catalysts. For example, as the person of ordinary skill in the art would appreciate, manganese is a common modifier used in Fischer-Tropsch catalysts, especially those based on cobalt. The present inventors also note that similar supports can be used for each.

Accordingly, in addition to the configurations described above, the present inventors contemplate the provision of a single bifunctional catalyst with both reverse water-gas shift activity and Fischer-Tropsch activity. Such a bifunctional catalyst includes both rWGS-active catalyst metal and the Fischer-Tropsch active catalyst metal in the same body. The person or ordinary skill in the art will appreciate that both the rWGS catalysts and the Fischer-Tropsch catalysts are supported catalyst, e.g., metal oxide supported catalyst. As such, in various embodiments of the present disclosure, the rWGS-active catalyst metals and Fischer-Tropsch active catalyst metals can be provided together on the same support to provide a bifunctional catalyst. For example, in some embodiments, the supports of bifunctional catalyst are provided themselves as discrete body of material, e.g., as porous particles, pellets, or shaped extrudates, with the rWGS-active catalyst metals and the FT-active catalyst metals provided thereon to provide a bifunctional catalyst. The rWGS-active catalyst metals and the FT-active catalyst metals may be homogenous distributed throughout the support or may be distributed in discrete areas throughout the support. However, in other embodiments, the bifunctional catalyst of the disclosure can itself be formed as a layer on an underlying substrate. For example, in some embodiments, the bifunctional catalyst is formed from a layer of rWGS-active catalyst metals and a layer of FT-active catalyst metals on an underlying substrate. The rWGS-active catalyst metals and the FT-active catalyst metals may be homogeneously distributed on the underlying substrate. In other embodiments, the rWGS-active catalyst metals and the FT-active catalyst metals may be in discrete areas on the underlying substrate. The underlying substrate is not particularly limited. It can be formed of, e.g., a metal or metal oxide, and can itself be provided in a number of forms, such as particles, pellets, shaped extrudates, or monoliths.

The bifunctional catalyst includes a support material, the rWGS-active catalyst metals as described herein, and the Fischer-Tropsch active catalyst metals as described herein. For example, the bifunctional catalyst includes a support that is a metal oxide support comprising at least one of titanium oxide, zirconium oxide, cerium oxide, or aluminum oxide. The rWGS-active catalyst metals and the Fischer-Tropsch active catalyst metals are not particularly limited, and the person of ordinary skill in the art would be able to select the appropriate metals. For example, the person or ordinary skill in the art would be able to select an appropriate rWGS active metal as described in Daza et al. “CO₂ conversion by reverse water gas shift catalysis: comparison of catalysts, mechanisms and their consequences for CO₂ conversion to liquid fuels.” RSC Adv., 2016, 6, 49675-49691, Zhu et al. “Catalytic Reduction of CO₂ to CO via Reverse Water Gas Shift Reaction: Recent Advances in the Design of Active and Selective Supported Metal Catalyst.” Transaction of Tianjin University, 2020, 26, 172-187, and Chen et al. “Recent Advances in Supported Metal Catalysts and Oxide Catalyst for the Reverse Water-Gas Shift Reaction.” Front. Chem., 2020, 8, 709. For example, the rWGS active metals may be selected from copper, platinum, palladium, rhodium, rhenium, ruthenium, nickel, gold, and iridium or combinations thereof. Similarly, the person of ordinary skill in the art would be able to select an appropriate Fischer-Tropsch active metal as described herein. For example, the Fischer-Tropsch active metal may be selected from cobalt, iron, rhodium, ruthenium, manganese, or combinations thereof.

The ratio of rWGS-active catalyst metals to FT-active catalyst metals in the bifunctional catalyst is not particularly limited and the person of ordinary skill in the art would be able to select an appropriate ratio. For example, in some embodiments, the ratio of rWGS-active catalyst metals to FT-active catalyst metals in the bifunctional catalyst is at least 0.1:1. In various embodiments, the ratio of rWGS-active catalyst metals to FT-active catalyst metals in the bifunctional catalyst is at least 0.2:1, or 0.5, or 1:1.

Such catalysts can be used in embodiments like those described with respect to FIG. 5. The person of ordinary skill in the art will select reaction conditions that provide the appropriate balance of reverse water-gas shift activity and Fischer-Tropsch activity.

FIG. 6 is a schematic depiction of another integrated process according to the disclosure. Here, the reverse water-gas shift and Fischer-Tropsch process steps are integrated together with partial oxidation of light hydrocarbons to provide CO and H₂ to the Fischer-Tropsch process step; electrolysis to provide H₂ for the reverse water-gas shift process step and O₂ for the partial oxidation; and various recycles and optional feeds, as described throughout the present specification.

Additional aspects of the disclosure are provided by the following enumerated embodiments, which may be combined in any number and in any combination that is not logically or technically inconsistent.

Embodiment 1. A process for performing an integrated Fischer-Tropsch process, the process comprising:
providing a first feed stream comprising H₂ and CO₂;
contacting at a first temperature in the range of 200-900° C. and at a first pressure a reverse water-gas shift catalyst with the first feed stream to perform a reverse water-gas shift reaction to provide a first product stream comprising CO and H₂, the first product stream having a lower concentration of CO₂ and a higher concentration of CO than the first feed stream;
contacting at a second temperature and at a second pressure a Fischer-Tropsch catalyst with a second feed stream comprising H₂ and at least a portion of CO of the first product stream to provide a second product stream comprising C₅₊ hydrocarbons.
   Embodiment 2. The process of embodiment 1, wherein the molar ratio of H₂ to CO₂ in the first feed stream is at least 0.1:1, e.g., at least 0.5:1.
   Embodiment 3. The process of embodiment 1 or embodiment 2, wherein the molar ratio of H₂ to CO₂ in the first feed stream is at least 0.9:1, e.g., at least 1:1 or at least 1.5:1.
   Embodiment 4. The process of any of embodiments 1-3, wherein the molar ratio of H₂ to CO₂ in the first feed stream is at least 2:1, e.g., at least 2.5:1.
   Embodiment 5. The process of any of embodiments 1-4, wherein the molar ratio of H₂ to CO₂ in the first feed stream is no more than 100:1, e.g., no more than 75:1, or 50:1.
   Embodiment 6. The process of any of embodiments 1-4, wherein the molar ratio of H₂ to CO₂ in the first feed stream is no more than 20:1, e.g., no more than 15:1, or 10:1.
   Embodiment 7. The process of any of embodiments 1-6, wherein the molar ratio of H₂ to CO₂ in the first feed stream is in the range of 0.5:1 to 10:1.
   Embodiment 8. The process according to any of embodiments 1-7, wherein the first feed stream further comprises CO.
   Embodiment 9. The process according to any of embodiments 1-8 wherein the first feed stream further comprises one or more inert gases (e.g., nitrogen and/or methane).
   Embodiment 10. The process of any of embodiments 1-9, wherein the reverse water-gas shift reaction has a CO selectivity of at least 70%, e.g., of at least 80%.
   Embodiment 11. The process of any of embodiments 1-9, wherein the reverse water-gas shift reaction has a CO selectivity of at least 85%, e.g., or at least 90%.
   Embodiment 12. The process of any of embodiments 1-11, wherein the reverse water-gas shift reaction has a CO selectivity of at least 95%, e.g., of at least 96%.
   Embodiment 13. The process of any of embodiments 1-11, wherein the reverse water-gas shift reaction has a CO selectivity of at least 98%, e.g., or at least 99%.
   Embodiment 14. The process of any of embodiments 1-13, wherein the reverse water-gas shift reaction has a methane selectivity of no more than 5%, e.g., no more than 4%.
   Embodiment 15. The process of any of embodiments 1-13, wherein the reverse water-gas shift reaction has a methane selectivity of no more than 2%, e.g., no more than 1%.
   Embodiment 16. The process of any of embodiments 1-13, wherein the reverse water-gas shift reaction has a methane selectivity of no more than 0.5%, e.g., no more than 0.2%.
   Embodiment 17. The process of any of embodiments 1-16, wherein the reverse water-gas shift reaction has a CO₂ conversion of at least 5%, e.g., at least 10%, or 20%.
   Embodiment 18. The process of any of embodiments 1-16, wherein the reverse water-gas shift reaction has a CO₂ conversion of at least 30%, e.g., at least 40%.
   Embodiment 19. The process of any of embodiments 1-18, wherein the reverse water-gas shift reaction has a CO₂ conversion of no more than 90%, e.g., no more than 80% or no more than 70%.
   Embodiment 20. The process of any of embodiments 1-18, wherein the reverse water-gas shift reaction has a CO₂ conversion of no more than 65%, e.g., no more than 60%.
   Embodiment 21. The process of any of embodiments 1-20, wherein the reverse water-gas shift reaction is conducted at a temperature in the range of 200-850° C., e.g., in the range of 200-800° C., 200-750° C., 200-700° C., or 200-650° C., or 200-600° C.
   Embodiment 22. The process of any of embodiments 1-20, wherein the reverse water-gas shift reaction is conducted at a temperature in the range of 250-900° C., e.g., in the range of 250-850° C., or 250-800° C., or 250-750° C., or 250-700° C., or 250-650° C., or 250-600° C.
   Embodiment 23. The process of any of embodiments 1-20, wherein the reverse water-gas shift reaction is conducted at a temperature in the range of 300-900° C., e.g., in the range of 200-850° C., or 200-800° C., or 300-750° C., or 300-700° C., or 300-650° C., or 300-600° C.
   Embodiment 24. The process of any of embodiments 1-20, wherein the reverse water-gas shift reaction is conducted at a temperature in the range of 350-900° C., e.g., in the range of 350-850° C., or 350-800° C., or 350-750° C., or 350-700° C., or 350-650° C., or 350-600° C.
   Embodiment 25. The process of any of embodiments 1-20, wherein the reverse water-gas shift reaction is conducted at a temperature in the range of 400-900° C., e.g., in the range of 400-850° C., or 400-800° C., or 400-750° C., or 400-700° C., or 400-650° C., or 400-600° C.
   Embodiment 26. The process of any of embodiments 1-20, wherein the reverse water-gas shift reaction is conducted at a temperature in the range of 450-900° C., e.g., in the range of 450-850° C., or 450-800° C., or 450-750° C., or 450-700° C., or 450-650° C., or 450-600° C.
   Embodiment 27. The process of any of embodiments 1-20, wherein the reverse water-gas shift reaction is conducted at a temperature in the range of 500-900° C., e.g., in the range of 500-850° C., or 500-800° C., or 500-750° C., or 500-700° C., or 500-650° C., or 500-600° C.
   Embodiment 28. The process of any of embodiments 1-20, wherein the reverse water-gas shift reaction is conducted at a temperature in the range of 550-900° C., e.g., in the range of 550-850° C., or 550-800° C., or 550-750° C., or 550-700° C., or 550-650° C., or 550-600° C.
   Embodiment 29. The process of any of embodiments 1-20, wherein the reverse water-gas shift reaction is conducted at a temperature in the range of 200-500° C., e.g., 200-450° C., or 200-400° C., or 200-350° C., or 250-500° C., e.g., 250-450° C., or 250-400° C., or 250-350° C.
   Embodiment 30. The process of any of embodiments 1-29, wherein the reverse water-gas shift reaction is conducted at a pressure in the range of 1 to 100 barg (e.g., in the range of 1 to 70 barg, or 1 to 50 barg, or 1 to 40 barg, or 1 to 35 barg, or 5 to 80 barg, or 5 to 50 barg, or 5 to 40 barg, or 5 to 35 barg, or 10 to 70 barg, 10 to 50 barg, or 10 to 40 barg, or 10 to 35 barg, or 20 to 70 barg, 20 to 50 barg, or 20 to 40 barg, or 20 to 35 barg, or 25 to 70 barg, 25 to 50 barg, or 25 to 40 barg, or 25 to 35 barg).
   Embodiment 31. The process of any of embodiments 1-30, wherein the reverse water-gas shift reaction is conducted at a GHSV in the range of 1,000 to 2,000,000 h⁻¹ (e.g., in the range of 1,000 to 1,200,000 h⁻¹, or 1,000 to 500,000 h⁻¹, or 1,000 to 100,000 h⁻¹, or 5,000 to 1,200,000 h⁻¹, or 5,000 to 500,000 h⁻¹, or 5,000 to 100,000 h⁻¹, or 10,000 to 1,200,000 h⁻¹, or 10,000 to 500,000 h⁻¹, or 10,000 to 100,000 h⁻¹).
   Embodiment 32. The process of any of embodiments 1-46, wherein the process comprises activating the reverse water-gas shift catalyst, e.g., prior to contacting the reverse water-gas shift catalyst with the first feed stream.
   Embodiment 33. The process of embodiment 32, wherein activating the rWGS catalyst comprises contacting the rWGS catalyst with a reducing stream comprising a reductive gas (e.g., hydrogen).
   Embodiment 34. The process of embodiment 32 or embodiment 33, wherein the reducing stream comprises hydrogen in an amount of at least 25 mol % (e.g., at least 50 mol %, or 75 mol %, or 90 mol %).
   Embodiment 35. The process of any of embodiments 32-34, wherein activating the rWGS catalyst is conducted at a temperature in the range of 200° C. to 800° C. (e.g., in the range of 250° C. to 800° C., or 300° C. to 800° C., or 200° C. to 700° C., or 250° C. to 700° C., or 300° C. to 700° C.).
   Embodiment 36. The process of any of embodiments 32-35, wherein activating the rWGS catalyst provides a catalyst that is at least 10% reduced (e.g., at least 25%, or 50%).
   Embodiment 37. The process of any of embodiments 1-36, wherein the first product stream comprises no more than 95 mol % CO₂ (e.g., no more than 90 mol % CO₂).
   Embodiment 38. The process of any of embodiments 1-36, wherein the first product stream comprises no more than 85 mol % CO₂ (e.g., no more than 80 mol % CO₂).
   Embodiment 39. The process of any of embodiments 1-36, wherein the first product stream comprises no more than 75 mol % CO₂ (e.g., no more than 70 mol % CO₂).
   Embodiment 40. The process of any of embodiments 1-36, wherein the first product stream comprises in the range of 5-95 mol % CO₂, e.g., 5-90 mol %, or 5-85 mol %, or 5-80 mol %, or 5-75 mol %, or 5-70 mol %, or 10-95 mol %, or 10-90 mol %, or 10-85 mol %, or 10-80 mol %, or 10-75 mol %, or 10-70 mol %, or 20-95 mol %, or 20-90 mol %, or 20-85 mol %, or 20-80 mol %, or 20-75 mol %, or 20-70 mol %, or 30-95 mol %, or 30-90 mol %, or 30-85 mol %, or 30-80 mol %, or 30-75 mol %, or 30-70 mol % CO₂.
   Embodiment 41. The process of any of embodiments 1-40, wherein the first product stream comprises no more than 20 mol % methane, e.g., no more than 15 mol % methane.
   Embodiment 42. The process of any of embodiments 1-40, wherein the first product stream comprises no more than 10 mol % methane, e.g., no more than 5 mol % or 1 mol %, or 0.5 mol %, or 0.1 mol % methane.
   Embodiment 43. The process of any of embodiments 1-42, wherein a ratio of H₂:CO in the first product stream is up to 100:1, e.g., up to 50:1, or up to 25:1, or up to 10:1.
   Embodiment 44. The process of any of embodiments 1-42, wherein a ratio of H₂:CO in the first product stream is in the range of 0.1:1 to 100:1 (e.g., in the range of 0.1:1 to 50:1, or 0.1:1 to 25:1, or 0.1:1 to 10:1, or 0.1:1 to 5:1, or 1:1 to 100:1, or 1:1 to 50:1, or 1:1 to 25:1, or 1:1 to 10:1, or 1:1 to 5:1).
   Embodiment 45. The process of any of embodiments 1-44, wherein the process further comprises separating the first product stream to recycle at least a portion of one or more components of the first product stream to the first feed stream.
   Embodiment 46. The process of any of embodiments 1-45, wherein the process further comprises separating the first product stream to recycle at least a portion (e.g., at least 5 mol %, at least 10 mol %, at least 25 mol %, at least 50 mol %, at least 75 mol %, or at least 90 mol %) of CO₂ of the first product stream to the first feed stream.
   Embodiment 47. The process of any of embodiments 1-46, wherein the process further comprises separating the first product stream to recycle at least a portion of H₂ (e.g., at least 5 mol %, at leat 10 mol %, at least 25 mol %, at least 50 mol %, at least 75 mol %, or at least 90 mol %) to the first feed stream.
   Embodiment 48. The process of any of embodiments 1-47, wherein the process further comprises separating at least a portion of H₂ and/or CO from the first product stream and contacting it with the Fischer-Tropsch catalyst to activate the Fischer-Tropsch catalyst.
   Embodiment 49. The process of any of embodiments 1-48, wherein the process further comprises removing at least a portion (e.g., at least 25%, at least 50%, or at least 75%) of water from the first product stream.
   Embodiment 50. The process according to any of embodiments 1-49, wherein the first product stream comprises one or more light hydrocarbons (e.g., methane, ethane, propane).
   Embodiment 51. The process according to embodiment 50, further comprising separating at least a portion of the one or more light hydrocarbons from the first product stream to provide a light hydrocarbon stream.
   Embodiment 52. The process of any of embodiments 1-51, wherein the process further comprises exchanging heat between at least a portion of the first product stream and at least a portion of the first feed stream, thereby cooling at least a portion of the first product stream and heating at least a portion of the first feed stream.
   Embodiment 53. The process of any of embodiments 1-52, wherein the process further comprises exchanging heat between at least a portion of the first product stream and a steam generation zone, thereby cooling at least a portion of the first product stream and providing heat to the steam generation zone.
   Embodiment 54. The process of embodiment 53, further comprising generating steam from the heat provided to the steam generation zone, and generating electricity from the steam.
   Embodiment 55. The process of embodiment 53 or 54, wherein steam is used to heat the first feed stream and/or the second feed stream.
   Embodiment 56. The process of any of embodiments 1-55, wherein at least 25% of the CO of the first product stream, e.g., at least 50% of the CO, at least 75% of the CO, or at least 90% of the CO of the first product stream is included in the second feed stream.
   Embodiment 57. The process of any of embodiments 1-56, wherein CO is provided to the second feed stream from a CO source other than the first product stream.
   Embodiment 58. The process of any of embodiments 1-57, wherein the first product stream includes H₂, and wherein the second feed stream includes at least a portion of the H₂ of the first product stream.
   Embodiment 59. The process of any of embodiments 1-58, wherein at least 25% of the H₂ of the first product stream, e.g., at least 50% of the H₂, at least 75% of the H₂, or at least 90% of the H₂ of the first product stream is included in the second feed stream.
   Embodiment 60. The process of any of embodiments 1-59, wherein H₂ is provided to the second feed stream from a hydrogen source other than the first product stream.
   Embodiment 61. The process of any of embodiments 1-60, wherein the second feed stream includes at least a portion of CO₂ of the first product stream.
   Embodiment 62. The process of any of embodiments 1-61, wherein at least 10% of the CO₂ of the first product stream, e.g., at least 25% of the CO₂, at least 50% of the CO₂, at least 75% of the CO₂, or at least 90% of the CO₂ of the first product stream is included in the second feed stream.
   Embodiment 63. The process of any of embodiments 1-61, wherein the second feed stream does not include a substantial amount of CO₂ of the first product stream.
   Embodiment 64. The process of any of embodiments 1-63, wherein the portion of the first product stream that is included in the second feed stream has a H₂:CO ratio in the range of 0.5:1 to 10:1, e.g., in the range of 1:1 to 3:1.
   Embodiment 65. The process of any of embodiments 1-64, wherein the portion of the first product stream that is included in the second feed stream has a water content of no more than 10 mol %, e.g., or no more than 2 mol %, or no more than 0.5 mol %.
   Embodiment 66. The process of any of embodiments 1-65, wherein the portion of the first product stream that is included in the second feed stream has a CO₂ content in the range of 10-95 mol % CO₂, e.g., 10-90 mol %, or 10-85 mol %, or 10-80 mol %, or 10-75 mol %, or 10-70 mol %, or 20-95 mol %, or 20-90 mol %, or 20-85 mol %, or 20-80 mol %, or 20-75 mol %, or 20-70 mol %, or 30-95 mol %, or 30-90 mol %, or 30-85 mol %, or 30-80 mol %, or 30-75 mol %, or 30-70 mol % CO₂.
   Embodiment 67. The process of any of embodiments 1-66, wherein the second feed stream has a H₂:CO ratio in the range of 0.5:1 to 6:1.
   Embodiment 68. The process of any of embodiments 1-66, wherein the second feed stream has a H₂:CO ratio in the range of 1:1 to 3:1, e.g., 1:1 to 2.5:1.
   Embodiment 69. The process of any of embodiments 1-66, wherein the second feed stream has a H₂:CO ratio of at least 1.4:1, e.g., in the range of 1.4:1 to 3:1, or 1.4:1 to 2.5:1.
   Embodiment 70. The process of any of embodiments 1-69, wherein the second feed stream includes up to 80% of one or more inerts, e.g., up to 70 mol %, up to 60 mol %, or up to 50 mol %, or 15-70 mol %, or 30-70 mol %, or 15-60 mol %, or 30-60 mol %, or 15-50 mol %, or 30-50 mol %.
   Embodiment 71. The process of any of embodiments 1-69, wherein the second feed stream includes up to 80% of one or more inerts selected from CO₂, methane and nitrogen, e.g., up to 70 mol %, up to 60 mol %, or up to 50 mol %, or 15-70 mol %, or 30-70 mol %, or 15-60 mol %, or 30-60 mol %, or 15-50 mol %, or 30-50 mol %.
   Embodiment 72. The process of any of embodiments 1-71, wherein the second feed stream includes up to 80% of CO₂, e.g., up to 70 mol %, up to 60 mol %, or up to 50 mol %, or 15-70 mol %, or 30-70 mol %, or 15-60 mol %, or 30-60 mol %, or 15-50 mol %, or 30-50 mol %.
   Embodiment 73. The process of any of embodiments 1-72, wherein the second feed stream has a water content of no more than 10 mol %, e.g., or no more than 2 mol %, or no more than 0.5 mol %.
   Embodiment 74. The process of any of embodiments 1-73, wherein the Fischer-Tropsch catalyst comprises cobalt, iron, rhodium, ruthenium, or a combination thereof.
   Embodiment 75. The process of any of embodiments 1-73, wherein the Fischer-Tropsch catalyst comprises cobalt, for example, in an amount in the range of 5-25 wt %, e.g., 7-25 wt %, or 10-25 wt %, or 5-20 wt %, or 7-20 wt %, or 10-20 wt %, calculated as Co(0).
   Embodiment 76. The process of any of embodiments 1-74, wherein the Fischer-Tropsch catalyst comprises iron, for example, in an amount in the range of 5-95 wt %, e.g., 10-95 wt %, or 25-95 wt %, or 50-95 wt %, or 5-85 wt %, or 10-85 wt %, or 25-85 wt %, or 50-85 wt %, or 5-75 wt %, or 10-75 wt %, or 25-75 wt %, calculated as Fe(0).
   Embodiment 77. The process of any of embodiments 74-76, wherein the Fischer-Tropsch catalyst further comprises manganese.
   Embodiment 78. The process of embodiment 77, wherein the manganese is present in an amount up to 15 wt %, e.g., up to 12 wt %, or up to 10 wt %, or up to 7 wt %, or in the range of 0.1-15 wt %, e.g., 0.1-10 wt %, or 0.1-5 wt %, 0.5-15 wt %, or 0.5-10 wt %, or 0.5-5 wt %, calculated as Mn(0).
   Embodiment 79. The process of any of embodiments 1-78, wherein the Fischer-Tropsch catalyst is a supported catalyst, wherein the support comprises at least one of titanium oxide, zirconium oxide, cerium oxide, aluminum oxide, silicon oxide and zinc oxide.
   Embodiment 80. The process of any of embodiments 1-78, wherein the Fischer-Tropsch catalyst is a supported catalyst, wherein the support comprises at least one of titanium oxide, aluminum oxide, and silicon oxide.
   Embodiment 81. The process of any of embodiments 1-78, wherein the Fischer-Tropsch catalyst is a supported catalyst, wherein the support is a titanium dioxide support.
   Embodiment 82. The process of any of embodiments 1-81, wherein the Fischer-Tropsch catalyst is activated by contact with a reducing gas, e.g., hydrogen.
   Embodiment 83. The process of embodiment 80, wherein the reducing gas comprises at least a portion of hydrogen from the first product stream.
   Embodiment 84. The process of any of embodiments 1-81, wherein the Fischer-Tropsch catalyst is activated by contact with H₂ and CO.
   Embodiment 85. The process of embodiment 84, wherein the reducing gas comprises at least a portion of H₂ and CO from the first product stream.
   Embodiment 86. The process of any of embodiments 82-84, wherein the activation is performed at a temperature in the range of 200-400° C.
   Embodiment 87. The process of any of embodiments 1-86, wherein the second temperature is in the range of 150-400° C. (e.g., in the range of 150-350° C., or 150-300° C., or 150-250° C., or 150-200° C., or 200-400° C., or 200-350° C., or 200-300° C., or 200-250° C., or 250-400° C., or 250-350° C., or 250-300° C., or 300-400° C.).
   Embodiment 88. The process of any of embodiments 1-87, wherein the second temperature is in the range of 200-350° C.
   Embodiment 89. The process of any of embodiments 1-88, wherein the first temperature is within 100° C. of the second temperature, e.g., within 50° C. of the second temperature, or within 25° C. of the second temperature.
   Embodiment 90. The process of any of embodiments 1-89, wherein the first temperature is at least 100° C. greater than the second temperature, e.g., at least 150° C. greater than the second temperature, or at least 200° C. greater than the second temperature.
   Embodiment 91. The process of any of embodiments 1-90, wherein the second pressure is in the range of 10-50 barg (e.g., 20-50 barg, or 25-50 barg, or 10-40 barg, or 20-40 barg, or 25-40 barg or 10-35 barg, or 20-35 barg, or 25-35 barg).
   Embodiment 92. The process of any of embodiments 1-91, wherein the second pressure is in the range of 20-50 barg.
   Embodiment 93. The process of any of embodiments 1-92, wherein the Fischer-Tropsch reaction is conducted at a GHSV in the range of 1,000 to 2,000,000 h⁻¹ (e.g., in the range of 1,000 to 1,200,000 h⁻¹, or 1,000 to 500,000 h⁻¹, or 1,000 to 100,000 h⁻¹, or 5,000 to 1,200,000 h⁻¹, or 5,000 to 500,000 h⁻¹, or 5,000 to 100,000 h⁻¹, or 10,000 to 1,200,000 h⁻¹, or 10,000 to 500,000 h⁻¹, or 10,000 to 100,000 h⁻¹).
   Embodiment 94. The process of any of embodiments 1-93, wherein the contacting of the Fischer-Tropsch catalyst with the second feed stream to provide the second product stream is performed with a C₅₊ selectivity of at least 30%, e.g., at least 50%, or at least 70%.
   Embodiment 95. The process of any of embodiments 1-94, wherein the contacting of the Fischer-Tropsch catalyst with the second feed stream to provide the second product stream is performed with a selectivity for C₅₊ alkanes of at least 30%, e.g., at least 50%, or at least 70%.
   Embodiment 96. The process of any of embodiments 1-95, wherein the contacting of the Fischer-Tropsch catalyst with the second feed stream to provide the second product stream is performed with a selectivity for C₅₊ alkanes and C₅₊ alcohols of at least 30%, e.g., at least 50%, or at least 70%.
   Embodiment 97. The process of any of embodiments 1-96, further comprising separating at least a portion of water from the second product stream.
   Embodiment 98. The process of any of embodiments 1-97, further comprising separating at least a portion of C₁-C₄ hydrocarbons from the second product stream to provide a light hydrocarbon stream.
   Embodiment 99. The process of embodiment 98, further comprising including at least a portion of the light hydrocarbon stream in the first feed stream and/or the second feed stream.
   Embodiment 100. The process of embodiment 98 or embodiment 99, further comprising oxidizing at least a portion of the light hydrocarbon stream to provide a CO- and/or CO₂-containing pOX stream, and including at least a portion of the pOX stream in the first feed stream and/or the second stream.
   Embodiment 101. The process of any of embodiments 98-100, further comprising reforming (e.g., steam reforming and/or autothermal reforming) at least a portion of the light hydrocarbon stream to provide a CO- and/or CO₂-containing reformed stream, and including at least a portion of the reformed stream in the first feed stream and/or the second feed stream.
   Embodiment 102. The process of embodiment 100 or embodiment 101, wherein the oxidation or the reforming provides energy, heat energy or electrical energy.
   Embodiment 103. The process of any of embodiments 98-102, further comprising burning at least a portion of the light hydrocarbon stream to provide energy, e.g., heat energy or electrical energy.
   Embodiment 104. The process of embodiment 102 or embodiment 103, wherein heat energy is provided, and the heat energy is used to heat the first feed stream.
   Embodiment 105. The process of any of embodiments 1-104, wherein the process further comprises exchanging heat between at least a portion of the second product stream and a steam generation zone, thereby cooling at least a portion of the first feed stream and providing heat to the steam generation zone.
   Embodiment 106. The process of embodiment 105, further comprising generating steam from the heat provided to the steam generation zone, and generating electricity from the steam.
   Embodiment 107. The process of embodiment 105 or 106, wherein steam is used to heat the first feed stream and/or the second feed stream.
   Embodiment 108. The process of any of embodiments 1-107, wherein the process further comprises exchanging heat between at least a portion of the second product stream and at least a portion of the second feed stream, thereby cooling at least a portion of the second product stream and heating at least a portion of the second feed stream.
   Embodiment 109. The process of any of embodiments 1-108, further comprising recycling at least a portion of H₂ of the second product stream to the second feed stream.
   Embodiment 110. The process of any of embodiments 1-109, further comprising recycling at least a portion of H₂ of the second product stream to the first feed stream.
   Embodiment 111. The process of embodiment 110, further comprising providing H₂ to the second feed stream from a H₂ source other than the first product stream.
   Embodiment 112. The process of embodiment 111, when H₂ from the second product stream makes up most of the H₂ of the first feed stream, e.g., at least 90%, at least 95%, or at least 98% of the H₂ of the first feed stream.
   Embodiment 113. The process of any of embodiments 1-112 further comprising recycling at least a portion of CO of the second product stream to the second feed stream.
   Embodiment 114. The process of any of embodiments 1-113, further comprising recycling at least a portion of CO of the second product stream to the first feed stream.
   Embodiment 115. The process of any of embodiments 1-114, further comprising recycling at least a portion of inerts of the second product stream to the second feed stream.
   Embodiment 116. The process of any of embodiments 1-115, further comprising recycling at least a portion of inerts of the second product stream to the first feed stream.
   Embodiment 117. The process of any of embodiments 1-116, further comprising recycling at least a portion of CO₂ of the second product stream to the first feed stream.
   Embodiment 118. The process of embodiment 117, further comprising providing CO₂ to the second feed stream from a CO₂ source other than the first product stream.
   Embodiment 119. The process of embodiment 118, when CO₂ from the second product stream makes up most of the CO₂ of the first feed stream, e.g., at least 90%, at least 95%, or at least 98% of the CO₂ of the first product stream.
   Embodiment 120. The process of any of embodiments 1-119, wherein one or more products are provided from at least a portion of C5+ hydrocarbons of the second product stream.
   Embodiment 121. The process of embodiment 120, wherein the one or more products include fuels (e.g., gasoline, diesel fuel, aviation fuel), lubricants and waxes.
   Embodiment 122. The process of any of embodiments 1-121, further comprising hydroprocessing at least a portion of C5+ hydrocarbons of the second product stream.
   Embodiment 123. The process of any of embodiments 1-122, wherein at least part of the CO₂ of the first feed stream and/or the second feed stream is from a renewable source.
   Embodiment 124. The process of any of embodiments 1-123, wherein at least part of the CO₂ of the first feed stream and/or the second feed stream is from direct air capture.
   Embodiment 125. The process of any of embodiments 1-124, wherein at least part of the CO₂ of the first feed stream and/or the second feed stream is captured from a manufacturing plant, e.g., a bioethanol plant, a steel plant, or a cement plant.
   Embodiment 126. The process of any of embodiments 1-125, wherein at least part of the H₂ of the first feed stream or the second feed stream is from a renewable source.
   Embodiment 127. The process of any of embodiment 1-126, wherein at least a portion of the hydrogen of the first feed stream or the second feed stream is green hydrogen.
   Embodiment 128. The process of any of embodiment 1-127, wherein at least a portion of the hydrogen of the first feed stream or the second feed stream is blue hydrogen.
   Embodiment 129. The process of any of embodiment 1-128, wherein at least a portion of the hydrogen of the first feed stream or the second feed stream is grey hydrogen, black hydrogen, brown hydrogen, pink hydrogen, turquoise hydrogen, yellow hydrogen, and/or white hydrogen.
   Embodiment 130. The process of any of embodiments 1-129, further comprising providing at least a portion of H₂ to the first feed stream and/or the second feed stream by electrolysis of water.
   Embodiment 131. The process of embodiment 130, wherein the electrolysis of water is performed using at least partially electricity from a renewable source.
   Embodiment 132. The process of embodiment 130 or embodiment 131, wherein the electrolysis of water is performed using at least partially electricity generated from steam made by heat exchange from the first product stream and/or the second product stream, or by burning a light hydrocarbon stream.
   Embodiment 133. The process of any of embodiments 130-132, further comprising providing at least a portion of 02 generated in the electrolysis to a partial oxidation.
   Embodiment 134. The process of any of embodiments 1-133, wherein the process is performed in a reactor system comprising a first reactor in which the reverse water-gas shift catalyst is disposed, and a second reactor in which the Fischer-Tropsch catalyst is disposed.
   Embodiment 135. The process of any of embodiments 1-134, wherein the process is performed in a reactor system comprising first catalyst bed in which the reverse water-gas shift catalyst is disposed, and wherein the second reaction zone comprises a second catalyst bed in which the Fischer-Tropsch catalyst is disposed.
   Embodiment 136. The process of embodiment 135, wherein the first reactor bed and the second reactor bed are disposed within the same reactor.
   Embodiment 137. The process of any of embodiments 1-133, wherein the process is performed in a reactor system comprising one or more first catalyst containers in which the reverse water-gas shift catalyst is disposed, and wherein the second reaction zone comprises one or more second catalyst containers in which the Fischer-Tropsch catalyst is disposed.
   Embodiment 138. The process of embodiment 137, wherein the one or more first catalyst containers and the one or more second catalyst containers are disposed within the same reactor.
   Embodiment 139. The process of any of embodiments 1-138, wherein the process is performed in a reactor system comprising a reactor in which the reverse water-gas shift catalyst and the Fischer-Tropsch catalyst are disposed, e.g., in admixture.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. Thus, before the disclosed processes and devices are described, it is to be understood that the aspects described herein are not limited to specific embodiments, apparatuses, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Numerous references have been made to patents and printed publications throughout this specification. Each of the cited references and printed publications are individually incorporated herein by reference in their entirety.

Furthermore, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

1-34. (canceled)

35. A process for performing an integrated Fischer-Tropsch process, the process comprising:
providing a first feed stream comprising H₂ and CO₂;
contacting at a first temperature in the range of 200-900° C. and at a first pressure a reverse water-gas shift catalyst with the first feed stream to perform a reverse water-gas shift reaction to provide a first product stream comprising CO and H₂, the first product stream having a lower concentration of CO₂ and a higher concentration of CO than the first feed stream;
contacting at a second temperature and at a second pressure a Fischer-Tropsch catalyst with a second feed stream comprising H₂ and at least a portion of CO of the first product stream to provide a second product stream comprising C₅₊ hydrocarbons.

36. The process of claim 35, wherein the molar ratio of H₂ to CO₂ in the first feed stream is in the range of 0.5:1 to 10:1.

37. The process of claim 35, wherein the reverse water-gas shift reaction has a CO selectivity of at least 95%.

38. The process of claim 35, wherein the reverse water-gas shift reaction has a methane selectivity of no more than 2%.

39. The process of claim 35, wherein the reverse water-gas shift reaction has a CO₂ conversion of at least 30%.

40. The process of claim 35, wherein the reverse water-gas shift reaction has a CO₂ conversion of no more than 80%.

41. The process of claim 35, wherein the reverse water-gas shift reaction is conducted at a temperature in the range of 400-700° C.

42. The process of claim 35, wherein the first product stream comprises no more than 75 mol % CO₂.

43. The process of claim 35, wherein the first product stream comprises no more than 5 mol % methane.

44. The process of claim 35, wherein the process further comprises separating the first product stream to recycle at least a portion of CO₂ of H₂ of the first product stream to the first feed stream.

45. The process of claim 35, wherein at least 25% of the CO of the first product stream is included in the second feed stream.

46. The process of claim 35, wherein the first product stream includes H₂, and wherein at least 25% of the H₂ of the first product stream is included in the second feed stream.

47. The process of claim 35, wherein at least 10% of the CO₂ of the first product stream is included in the second feed stream.

48. The process of claim 35, wherein the second feed stream does not include a substantial amount of CO₂ of the first product stream.

49. The process of claim 35, wherein the second feed stream has a H₂:CO ratio in the range of 0.5:1 to 6:1.

50. The process of claim 35, wherein the Fischer-Tropsch catalyst comprises cobalt, iron, rhodium, ruthenium, or a combination thereof.

51. The process of claim 50, wherein the Fischer-Tropsch catalyst further comprises manganese.

52. The process of claim 35, wherein the second temperature is in the range of 200-350° C.

53. The process of claim 35, wherein the first temperature is at least 100° C. greater than the second temperature.

54. The process of claim 35, wherein the contacting of the Fischer-Tropsch catalyst with the second feed stream to provide the second product stream is performed with a selectivity for C₅₊ alkanes of at least 30%.
